(19) United States
(12) Patent Application Publication
(10) Pub. No.: US 2025/0336377 A1
(43) Pub. Date: Oct. 30, 2025

(54) Musical Instrument Systems and Related Methods

(71) Applicant: Rock-In-Tune LLC, West Jordan, UT (US)

(72) Inventor: Carlos Eduardo Ferreira, West Jordan, UT (US)

(73) Assignee: Rock-In-Tune LLC, West Jordan, UT (US)

(21) Appl. No.: 19/032,470

(22) Filed: Jan. 21, 2025

Related U.S. Application Data
(60) Provisional application No. 63/638,221, filed on Apr. 24, 2024.

(51) Int. Cl. G10D 3/04; G10D 3/12

(52) U.S. Cl. CPC G10D 3/04; G10D 3/12

(57) ABSTRACT

Disclosed herein are musical instrument systems which allow a user to swap out a set of strings of a stringed instrument, having a first configuration, with another set of strings having a second configuration. For example, a first set of strings having a first tuning may be swapped out for a second set of strings having a second tuning. Modular string systems which are swapped out in this way may include bridge and nut components.

### CROSS REFERENCE TO RELATED APPLICATIONS

This document claims the benefit of the filing date of U.S. Provisional Patent Application No. 63/638,221, entitled “Musical Instrument Systems and Related Methods,” naming as first inventor Carlos Eduardo Ferreira, which was filed on Apr. 24, 2024, the disclosure of which is hereby incorporated entirely herein by reference.

### BACKGROUND

### 1. Technical Field

Aspects of this document relate generally to stringed musical instrument systems and methods. Particular aspects relate to guitar systems and methods.

### 2. Background Art

Stringed musical instruments are configured to produce sound from vibrating strings. Strings can be vibrated by plucking or striking the strings with a finger, hand, pick or, in some cases, using a hammer element or rubbing the strings with a bow. On a variety of stringed instruments the strings may be tuned by adjusting string tension. A variety of tunings may be used by a musician depending on the song(s) to be played. Standard tuning for six-string guitars for example is E-A-D-G-B-E. A variety of other tunings exist, such as major open-tunings giving a major chord with the open strings, such as an open A tuning E-A-E-A-C#-E, an open G tuning D-G-D-G-B-D, and so forth. Switching a stringed musical instrument from one tuning to another, such as for playing a specific song, is time consuming and inconvenient enough that musicians often use different guitars pre-set to different tunings prior to a show, performance or practice.

### SUMMARY

In some aspects, the techniques described herein relate to a musical instrument system, including: a bridge module including: a bridge body; one or more first string clamps coupled with the bridge body or configured to couple with the bridge body, the one or more first string clamps configured to releasably couple a plurality of strings of a musical instrument with the bridge body; and one or more first engagement members coupled with the bridge body or configured to couple with the bridge body, the one or more first engagement members configured to engage with one or more second engagement members of a bridge baseplate to releasably couple the bridge body with the bridge baseplate, at least in part using tension from the plurality of strings, when the bridge baseplate is secured to the musical instrument; and a nut module including: a nut body; one or more second string clamps coupled with the nut body and configured to releasably couple the plurality of strings with the nut body; and one or more third engagement members coupled with the nut body or configured to couple with the nut body, the one or more third engagement members configured to engage with one or more fourth engagement members of a nut baseplate to releasably couple the nut body with the nut baseplate when the nut baseplate is secured to the musical instrument.

In some aspects, the techniques described herein relate to a musical instrument system, wherein the one or more first engagement members include one or more projections extending downward from a bottom surface of the bridge body, the bottom surface facing toward the musical instrument in an installed configuration.

In some aspects, the techniques described herein relate to a musical instrument system, wherein the one or more first engagement members are integrally formed with the bridge body or are permanently secured to the bridge body.

In some aspects, the techniques described herein relate to a musical instrument system, wherein the one or more first engagement members are manually removable from the bridge body.

In some aspects, the techniques described herein relate to a musical instrument system, wherein the one or more first engagement members include one or more engagement screws.

In some aspects, the techniques described herein relate to a musical instrument system, wherein the one or more first engagement members include one or more wedges.

In some aspects, the techniques described herein relate to a musical instrument system, wherein the one or more second string clamps include one or more clamping screws.

In some aspects, the techniques described herein relate to a musical instrument system, wherein the one or more third engagement members include one or more guide pins.

In some aspects, the techniques described herein relate to a musical instrument system, wherein the one or more third engagement members include one or more angled surfaces.

In some aspects, the techniques described herein relate to a musical instrument system, wherein the nut module further includes a tensioner configured to, when adjusted, move the nut body to simultaneously adjust a tension of all of the strings.

In some aspects, the techniques described herein relate to a musical instrument system, wherein the bridge module further includes a tensioner configured to, when adjusted, move the bridge body to simultaneously adjust a tension of all of the strings.

In some aspects, the techniques described herein relate to a musical instrument system, wherein the bridge module further includes a plurality of adjustable string saddles, each string saddle configured to be adjusted to adjust an intonation of one of the plurality of strings.

In some aspects, the techniques described herein relate to a musical instrument system, wherein the bridge module further includes a plurality of fine tuners, each fine tuner configured to be adjusted to adjust a tension of one of the plurality of strings.

In some aspects, the techniques described herein relate to a musical instrument system, including: a bridge module including: a bridge body; one or more first string clamps coupled with the bridge body or configured to couple with the bridge body, the one or more first string clamps configured to releasably couple a plurality of strings of a musical instrument with the bridge body; and one or more first engagement members coupled with the bridge body or configured to couple with the bridge body; a bridge baseplate configured to be secured to the musical instrument, the bridge baseplate including one or more second engagement members, wherein the one or more first engagement members are configured engage with the one or more second engagement members to releasably couple the bridge body with the bridge baseplate, at least in part using tension from the plurality of strings, when the bridge baseplate is secured to the musical instrument; a nut module including: a nut body; one or more second string clamps coupled with the nut body and configured to releasably couple the plurality of strings with the nut body; and one or more third engagement members coupled with the nut body or configured to couple with the nut body; and a nut baseplate configured to be secured to the musical instrument, the nut baseplate including one or more fourth engagement members, wherein the one or more third engagement members are configured to engage with the one or more fourth engagement members to releasably couple the nut body with the nut baseplate when the nut baseplate is secured to the musical instrument.

In some aspects, the techniques described herein relate to a musical instrument system, wherein the one or more second engagement members include a channel.

In some aspects, the techniques described herein relate to a musical instrument system, further including a tensioner coupled with the bridge baseplate and configured to, when adjusted, move the bridge body to simultaneously adjust a tension of all of the strings.

In some aspects, the techniques described herein relate to a musical instrument system, wherein the bridge baseplate further includes: a tremolo arm interface configured to couple with a tremolo arm; and a tremolo block interface configured to couple with a tremolo block.

In some aspects, the techniques described herein relate to a musical instrument system, further including a height-adjustable tremolo leveling tool configured to be placed under the bridge baseplate to keep the bridge baseplate level during one of: coupling the bridge body with the bridge baseplate; and decoupling the bridge body from the bridge baseplate.

In some aspects, the techniques described herein relate to a method of use of a musical instrument system, including: releasably coupling a plurality of strings of a musical instrument with a bridge body of a bridge module using one or more first string clamps coupled with the bridge body; releasably coupling the plurality of strings with a nut body of a nut module using one or more second string clamps coupled with the nut body; securing a bridge baseplate to the musical instrument; securing a nut baseplate to the musical instrument; engaging one or more first engagement members, coupled with the bridge body, with one or more second engagement members of the bridge baseplate to releasably couple the bridge body with the bridge baseplate; and engaging one or more third engagement members, coupled with the nut body, with one or more fourth engagement members of the nut baseplate to releasably couple the nut body with the nut baseplate.

In some aspects, the techniques described herein relate to a method, further including simultaneously adjusting a tension of all of the strings by adjusting a tensioner coupled with one of the nut body, the bridge body, and the bridge baseplate; wherein the tensioner simultaneously adjusts the tension of all of the strings by moving one of the bridge body and the nut body. General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale. It is pointed out that the nomenclature of top/bottom and front/rear changes from some views to others. For example, when referring to guitars or fully-assembled musical instrument systems, FIG. 4 shows a “front” view of each. However, in referring to specific components of the musical instrument systems, it is more convenient to refer to the portion of those components facing out of the page in the front view of FIG. 4 as the “top” of those components. Accordingly, for example, the top of the bridge module (not the front of the bridge module) and the top of the nut module (not the front of the nut module) face out of the page in the “front” view of the musical instrument system and “front” view of the guitar of FIG. 4.

FIG. 1 is a front view of a prior art guitar;

FIG. 2 is a close-up front view of a portion of the prior art guitar of FIG. 1;

FIG. 3 is a close-up rear view of a portion of the prior art guitar of FIG. 1;

FIG. 4 is a front view of an implementation of a musical instrument system and some elements of the prior art guitar of FIG. 1;

FIG. 5 is a top, right, rear perspective close-up view of a bridge module of the musical instrument system of FIG. 4 and a portion of the strings of the guitar of FIG. 4;

FIG. 6 is a bottom, right, rear perspective close-up view of the bridge module and the portion of strings of FIG. 5;

FIG. 7 is a top, right, rear perspective view of a bridge baseplate of the musical instrument system of FIG. 4;

FIG. 8 is a bottom, right, rear perspective view of the bridge baseplate of FIG. 7;

FIG. 9 is a top, right, rear perspective view of the bridge baseplate of FIG. 7 secured to a tremolo block and having a tremolo arm assembly coupled thereto;

FIG. 10 is a top, right, front perspective view of a bridge body of the bridge module of FIG. 5;

FIG. 11 is a bottom, right, front perspective view of the bridge body of FIG. 10;

FIG. 12 is a left, front, top perspective view of another implementation of a bridge body;

FIG. 13 is a rear, bottom, right perspective view of a string saddle of the bridge module of FIG. 5;

FIG. 14 is a rear, right, top perspective view of the string saddle of FIG. 13;

FIG. 15 is a right, front, top perspective view of elements of the bridge module of FIG. 5;

FIG. 16 is a left, front, top perspective view of a string clamp of the string clamp assembly of FIG. 18;

FIG. 17 is a left, rear, top perspective view of a string clamp of the string clamp assembly of FIG. 18;

FIG. 18 is a left, rear, top perspective view of a string clamp assembly of the bridge module of FIG. 5;

FIG. 19 is a front, left, top perspective view of a fine tuner knob and bearing washer of the bridge module of FIG. 5;

FIG. 20 is a front, left, top perspective view of the elements of FIG. 19 coupled with the string clamp assembly of FIG. 18;

FIG. 21 is a top, front, right perspective view of a nut module of the musical instrument system of FIG. 4;

FIG. 22 is a top, front, right perspective view of a nut body and other elements of the nut module of FIG. 21;

FIG. 23 is a top, front, right perspective view of a nut baseplate of the nut module of FIG. 21;

FIG. 24 is a top, front, right perspective view of a tremolo leveling tool;

FIG. 25 is a rear, right, top perspective view of another implementation of a nut module;

FIG. 26 is a rear, right, top perspective view of a removable nut body of the nut module of FIG. 25;

FIG. 27 is a front, right, top perspective view of a nut baseplate of the nut module of FIG. 25;

FIG. 28 is a front, left, top perspective view of another implementation of a bridge module;

FIG. 29 is a front, left, top perspective view of the bridge module of FIG. 28, the nut module of FIG. 25, a tremolo block, and portions of guitar strings;

FIG. 30 is a front, left, top perspective view of a bridge baseplate of the bridge module of FIG. 29;

FIG. 31 is a bottom, rear, right perspective view of another implementation of a bridge module, a tremolo block, and portions of guitar strings;

FIG. 32 is a top, right, perspective view of the bridge module of FIG. 31, the nut module of FIG. 25, and portions of guitar strings;

FIG. 33 is a rear, right, bottom perspective view of a bridge body of the bridge module of FIG. 31;

FIG. 34 is a rear, right, bottom perspective view of a bridge baseplate of the bridge module of FIG. 31;

FIG. 35 is a left, front, top, close-up partial perspective view of elements of another musical instrument system;

FIG. 36 is a right, rear, top, close-up partial perspective view of elements of the musical instrument system of FIG. 35;

FIG. 37 is a left, front, top, perspective view of a nut module of the musical instrument system of FIG. 35 and portions of strings of a guitar;

FIG. 38 is a top, front view of some of the elements of the musical instrument system of FIG. 35;

FIG. 39 is a bottom, front, left perspective view of the elements of FIG. 38;

FIG. 40 is a front view of the elements of FIG. 35;

FIG. 41 is a rear, left, top perspective view of the elements of FIG. 36;

FIG. 42 representatively illustrates portions of a method of installation of a musical instrument system;

FIG. 43 representatively illustrates additional portions of a method of installation of a musical instrument system;

FIG. 44 representatively illustrates additional portions of a method of installation of a musical instrument system;

FIG. 45 representatively illustrates additional portions of a method of installation of a musical instrument system;

FIG. 46 representatively illustrates additional portions of a method of installation of a musical instrument system;

FIG. 47 representatively illustrates additional portions of a method of installation of a musical instrument system;

FIG. 48 representatively illustrates additional portions of a method of installation of a musical instrument system;

FIG. 49 representatively illustrates portions of a method of uninstalling a musical instrument system;

FIG. 50 representatively illustrates additional portions of a method of uninstalling a musical instrument system;

FIG. 51 representatively illustrates additional portions of a method of uninstalling a musical instrument system;

FIG. 52 representatively illustrates a method of use of a musical instrument system.

FIG. 53 is a rear, right, top perspective view of another implementation of a bridge module;

FIG. 54 is a rear, bottom, right perspective view of the bridge module of FIG. 53;

FIG. 55 is a right view of the bridge module of FIG. 53;

FIG. 56 is a rear view of the bridge module of FIG. 53;

FIG. 57 is a front, bottom, right perspective view of the bridge module of FIG. 53;

FIG. 58 is a rear, right, bottom perspective view of another implementation of a bridge module;

FIG. 59 is a right, rear, top perspective view of another implementation of a bridge baseplate;

FIG. 60 is a right, rear, bottom perspective view of the bridge baseplate of FIG. 59;

FIG. 61 is a right, rear, top perspective view of a bridge body of the bridge module of FIG. 53 coupled with the bridge baseplate of FIG. 59;

FIG. 62 is a right, rear, top perspective cross-section view of the elements of FIG. 61;

FIG. 63 is a right cross-section view of the elements of FIG. 61;

FIG. 64 is a right, top, front perspective view of another implementation of a nut module; and

FIG. 65 is a front, top, right perspective view of a nut baseplate of the nut module of FIG. 64.

### DESCRIPTION

Implementations/embodiments disclosed herein (including those not expressly discussed in detail) are not limited to the particular components or procedures described herein. Additional or alternative components, assembly procedures, and/or methods of use consistent with the intended musical instrument systems and related methods may be utilized in any implementation. This may include any materials, components, sub-components, methods, sub-methods, steps, and so forth.

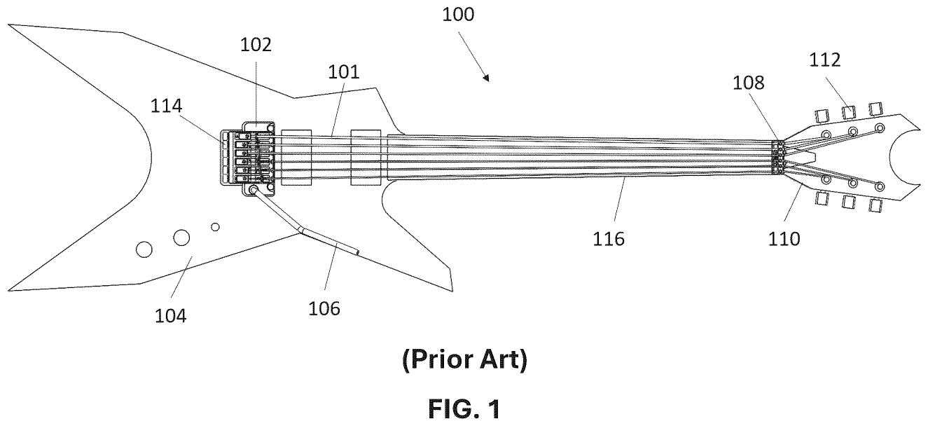

Referring to FIG. 1, a prior art guitar 100 is shown. Some prior art guitars have fixed bridges which secure the strings 101 to the body of the guitar. Fixed bridges provide means for adjusting intonation of the strings (including saddles that can move along the string direction) and also provide means for adjusting string height (by raising or lowering bridge posts or saddles). The prior art guitar of FIG. 1, instead of having a fixed bridge, has a tremolo bridge 102 which secures the strings to the body 104 of the guitar. The tremolo bridge has the same functions/elements as a fixed bridge plus provides means for varying the pitch of the strings while playing the guitar using the tremolo arm 106. The nut 108 keeps the strings apart at the headstock 110. The tuners 112 (or machine heads) are used to tension and therefore tune the strings. Some guitars include locking nuts. These have the same functions as nuts 108 but also lock the strings so they don't go out of tune when the tremolo arm is used. The tuners used with locking nuts function the same way as regular tuners but become temporarily disabled (for tuning) after the nut is locked. The fine tuners 114 may be used for tuning while the nut is locked, however, and if the nut is again unlocked the tuners 112 may again be used for tuning. The strings extend along the neck 116 from the machine heads to the bridge.

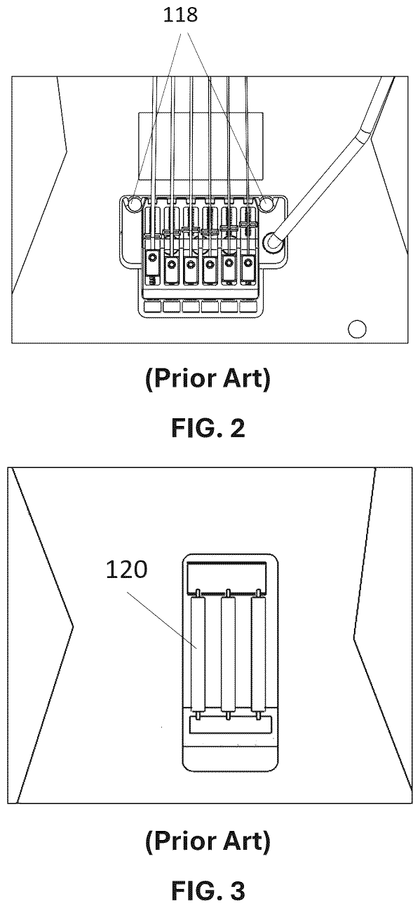

FIG. 2 shows a close-up view of a portion of the prior art guitar of FIG. 1. The tremolo bridge is part of a double-locking tremolo system. By “double-locking” it is meant that the strings are locked at the bridge and at the nut. This type of bridge has been a staple for rock and metal music focused guitars. The bridge must “float” on the two bridge posts 118 and stay leveled with the guitar body to work properly. This is achieved with the use of tremolo springs 120 (three of which are shown in FIG. 3) attached to the tremolo block and the guitar at the back side of the guitar. This balancing of the tension in the strings and in the springs is very sensitive, and tuning a guitar with such a system is tedious. Once the tuning is set, most guitarists will not want to change the tuning.

There are challenges with prior art tremolo bridges/systems. Some guitarists want to have guitars with double-locking tremolo systems but also want to be able to play different songs in different tunings. In order to change the tuning, most often the string gauge needs to be changed (to maintain the same string tension and/or feel as a standard tuning). Once the string gauge is changed, it can throw off the intonation, spring adjustment, neck bow, etc. In short, to change the tuning in guitars with the double-locking tremolo system, a user would spend about thirty minutes changing the strings and then re-adjusting everything (if the user is experienced). A beginner may take hours, and the average person would take about one to two hours. To avoid this hassle, it is common for guitarists to have a few guitars to cover the different tunings that they use most frequently. This is expensive since a medium-level guitar costs several hundred dollars. In addition, having multiple guitars and their cases takes up significant space.

Musical instrument systems and methods disclosed herein address, among other things, the above issues. In some cases the systems and methods discussed herein may be considered a retrofit—for example a retrofit solution for a common (and/or the most common) tremolo bridge on the market. The systems and methods disclosed herein maintain all functionality of the original double-locking tremolo systems but allow the guitarist to use different tunings with the same guitar. In implementations it takes less than five minutes to swap out a module, put another in, and fine tune each string. In some implementations the systems disclosed herein could be integrally incorporated with a guitar or other string instrument such that the instrument having the modular string system is sold as a unit and no retrofit is needed.

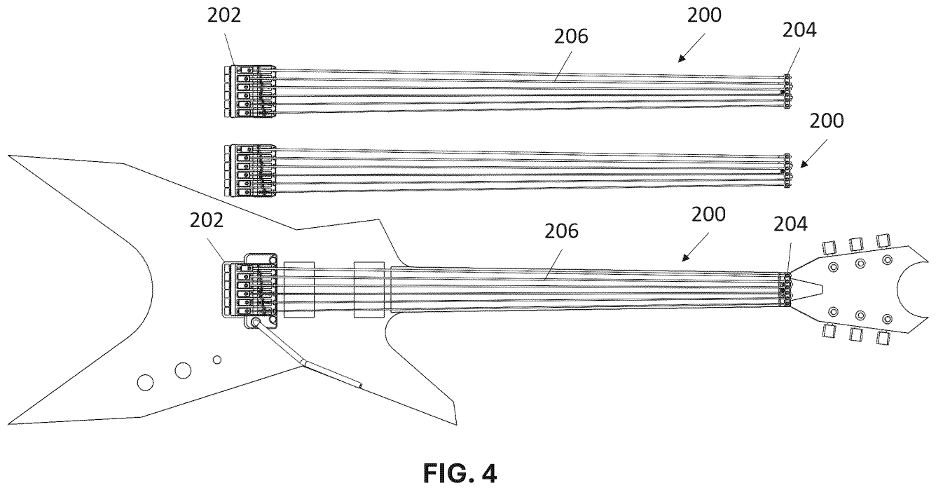

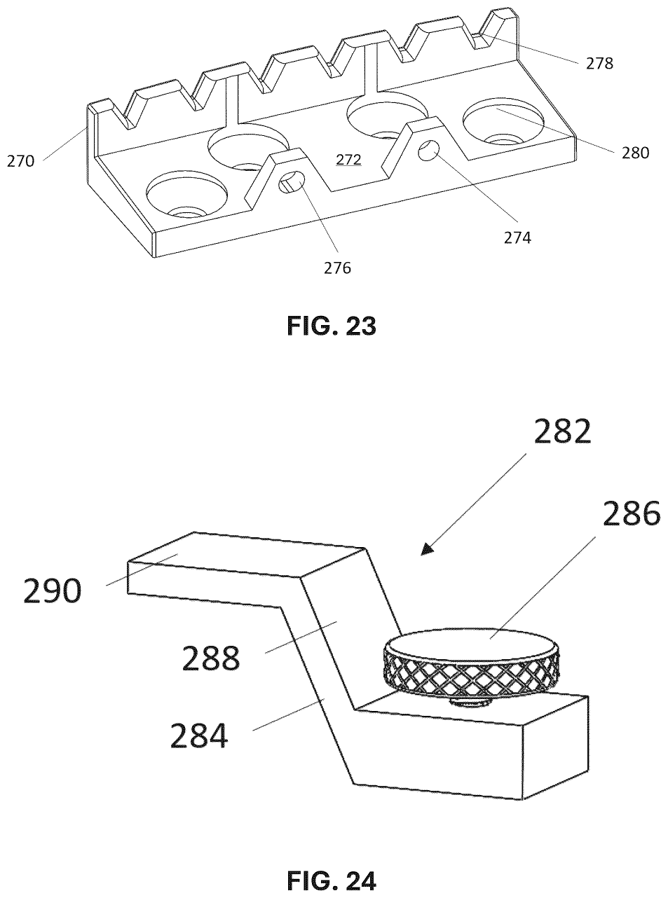

Referring now to FIG. 4, implementations of musical instrument systems 200 are shown. These may also be called modular string systems, and each is removable/reusable. Each system 200 includes a bridge module 202 and a nut module 204, and the user may add their own strings 206. Some nut modules include nut baseplate 270 (seen in FIG. 23) and some exclude it. Similarly, some bridge modules include a bridge baseplate 208 and some exclude it. For example, in some cases a kit may be sold which includes one bridge baseplate 208 and one nut baseplate 270, but multiple bridge modules 202 and multiple nut modules-once the user attaches the bridge baseplate and the nut baseplate on the guitar they may remain installed. The user can attach their own strings to each pair of bridge module and nut module to have removable/replaceable tuning setups or, in some cases, the kit may itself include strings. In some cases the kit could include strings, but in some cases it may exclude strings. Additionally since the bridge baseplate and nut baseplate, once installed, may not need to be replaced from tuning to tuning, some additional kits may be sold which include one or more bridge modules and/or one or more nut modules but which do not include bridge baseplates or nut baseplates. In the example of FIG. 4 the bottommost system 200 is installed on a guitar and has standard tuning, the middle system 200 has a first alternate tuning, and the top system 200 has a second alternate tuning. The systems 200 can be set up with different tunings and swapped onto and off the guitar or other string instrument as desired. There is no limit to the number of systems 200 that can be set up with alternate tunings. Each system 200 can also be adapted to any number of strings, the example of six strings shown in FIG. 4 (for use with a typical six-string guitar) is only one representative example.

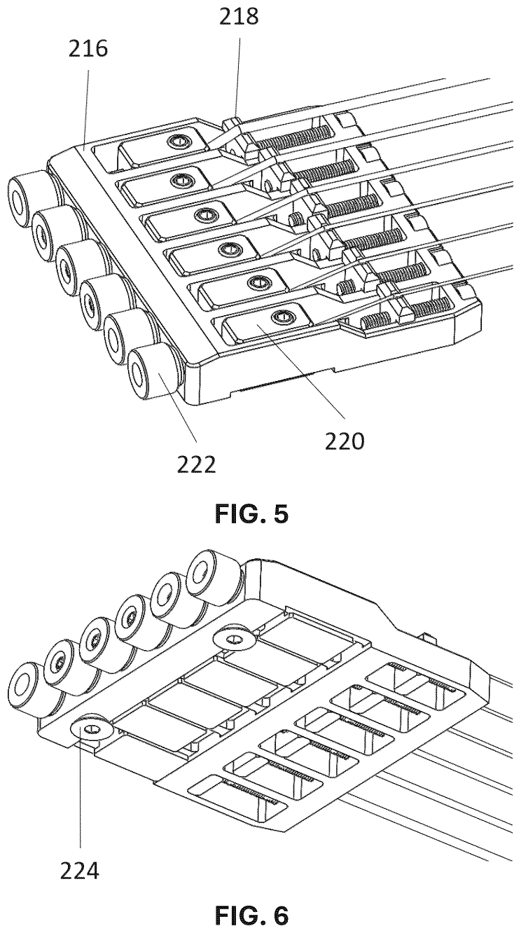

Referring now to FIGS. 5-6, in implementations the bridge module 202 includes a bridge body 216, string saddles 218, string clamps 220, string fine tuners 222 (which may also be called fine tuner nuts or fine tuner knobs or simply fine tuners), and engagement screws 224 (among other elements, in some cases). The bridge body holds and/or engages or couples with the adjustable string saddles, the string clamps, the string fine tuners and a pair of engagement screws. The engagement screws interface with a bridge baseplate to secure the bridge module in place while the strings are being tensioned (and thereafter).

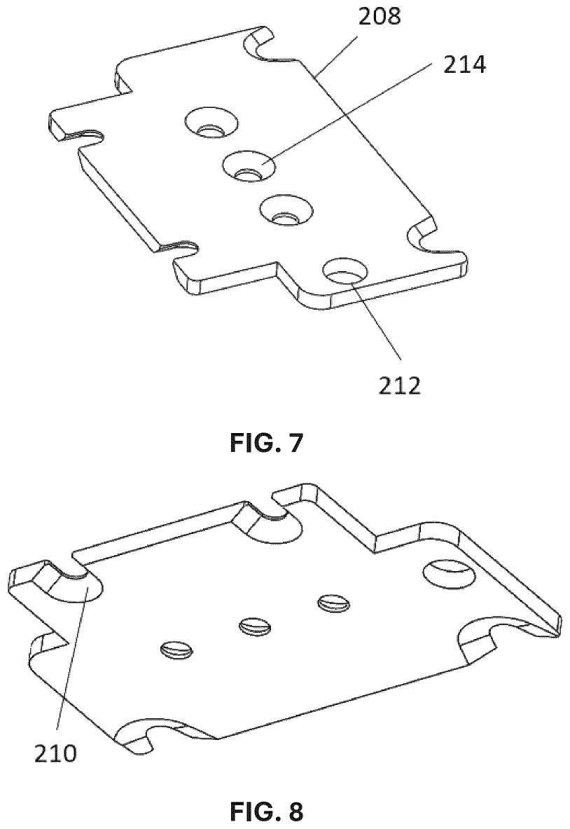

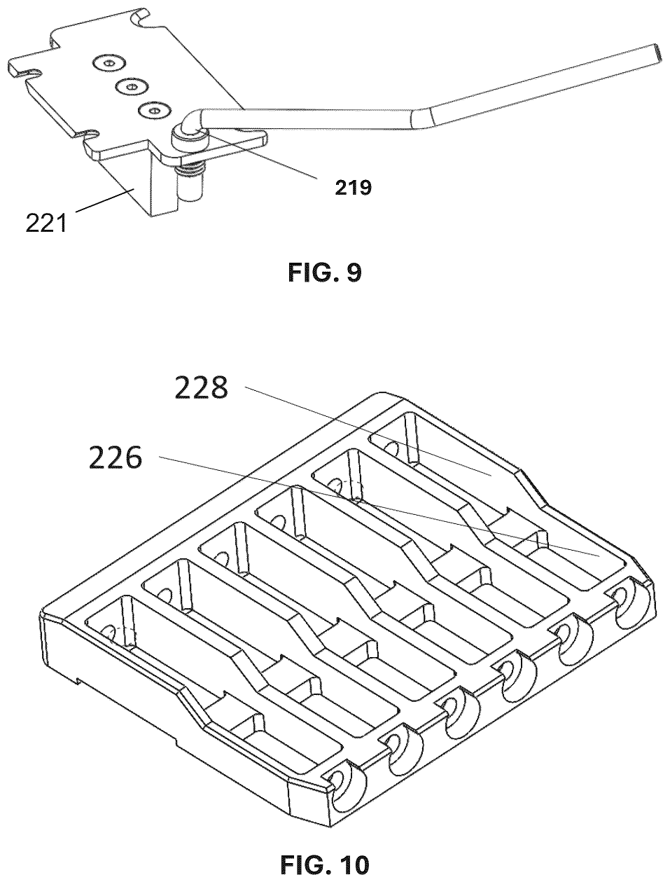

Referring now to FIGS. 7-9, the bridge baseplate 208 of system 200 is specifically designed to receive the bridge module and includes chamfered channels 210 for engagement with the engagement screws 224 of the bridge module. The bridge baseplate can be adapted to be used with fixed or tremolo style bridges. In the case of tremolo style bridges, the bridge baseplate also includes a tremolo arm interface 212 (which in the shown example includes a through hole with or without threads) and a tremolo block interface 214 (which in the shown example includes three countersunk holes through which screws or the like, seen in FIG. 9, can be used to secure the bridge baseplate 208 to a tremolo block 221). FIGS. 7-9 show a bridge baseplate adapted for use with tremolo bridge systems. An improved tremolo arm assembly 219 is included in some implementations and has a shorter vertical section than with prior art tremolo arms, to prevent interference with the guitarist's picking hand. In implementations the tremolo arm may be raised or lowered by approximately 10 mm as desired (and then tightened to secure it to the set height).

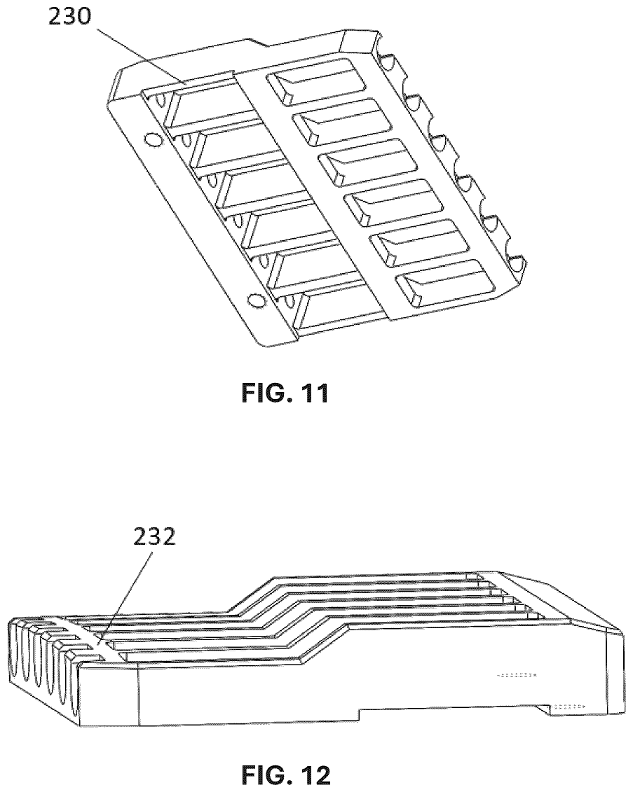

Referring now to FIGS. 10-11, in implementations the bridge body includes saddle channels 226 which work as guides for the adjustable saddles, string clamp channels 228 which work as guides for the string clamps, and cutouts 230 to interface with the string clamp retaining lips. The saddles can move along saddle channels to provide intonation adjustment. The string clamps can move along string clamp channels to provide tuning capability. In an alternate bridge body embodiment shown in FIG. 12, the top 232 of the saddle channels can be curved or radiused (providing a curved saddle interface) to match the curvature of the guitar fretboard.

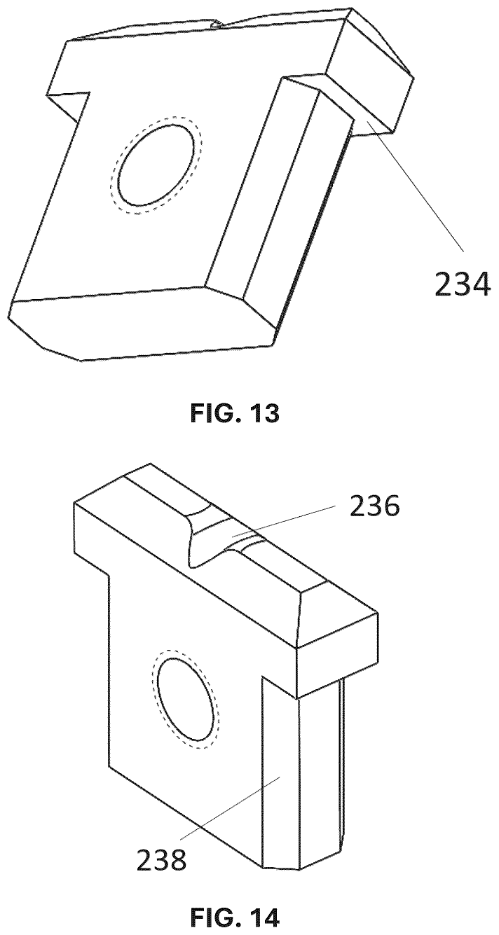

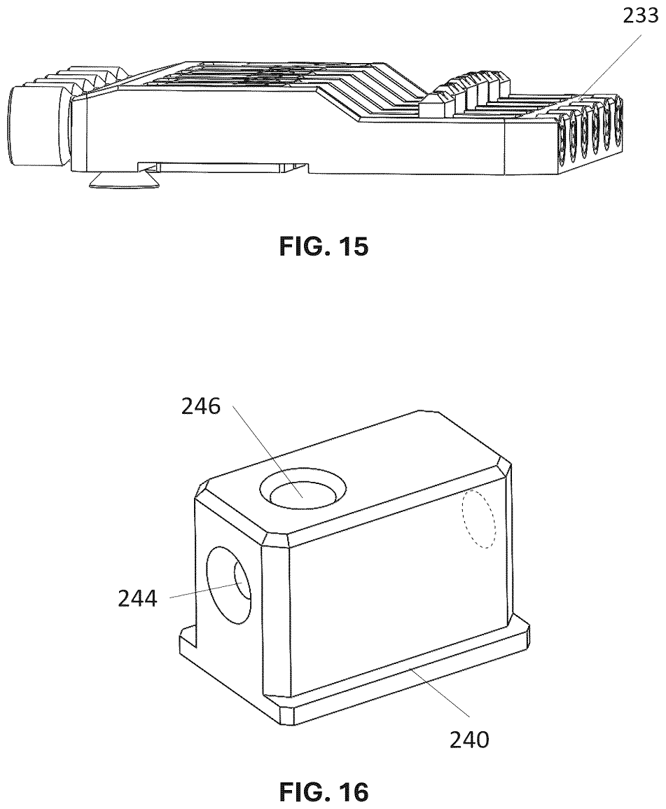

Referring now to FIGS. 13-15, in implementations each string saddle includes interface lips 234, a radiused notch 236, and beveled edges 238 to allow full range of motion. The radiused notch provides a smooth interface with the strings to accommodate the angle formed with the string clamps and prevent string breakage. FIG. 15 representatively illustrates saddles of different heights to match the radius of the fretboard (while the top 233 is flat). An alternate saddle embodiment is one that has only one height and the fretboard radius is achieved with the radius present in the alternate bridge body embodiment of FIG. 12 which has inherent curvature.

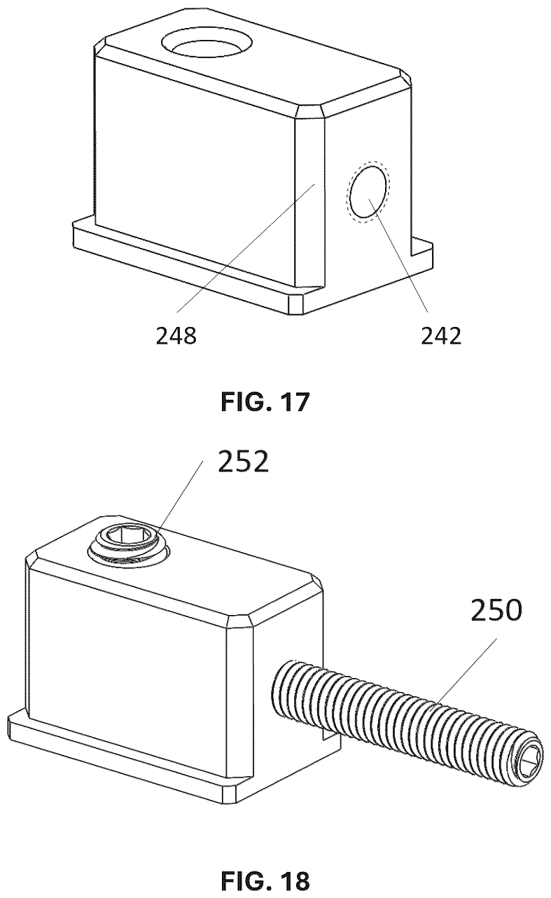

Referring now to FIGS. 16-18, in implementations each string clamp includes lateral retaining lips 240, a fine tuner screw interface 242, a string receiver hole 244, a string clamping screw interface 246, and beveled corners 248 (which may also be called beveled edges) to allow full range of motion. The retaining lips resist the vertical force created by the tensioned string. The clamps are connected to the fine tuners by means of typical machine set screws 250 which may be permanently attached (though in some cases could be removable). The set screw goes through the bridge body and interfaces with the fine tuner knob. The fine tuner knob converts rotational movement into translational movement by means of the thread pitch. This type of movement transfer is used in machinery to tension belts and chains, and is adapted here to tension the guitar string. The clamps contain blind holes where the strings are inserted and then clamped with a typical machine set screw 252. Such set screws are used in machinery to secure shafts and rods in place and are adapted here to secure the strings against the string clamps. The elements of FIG. 18 together may be said to form a string clamp assembly.

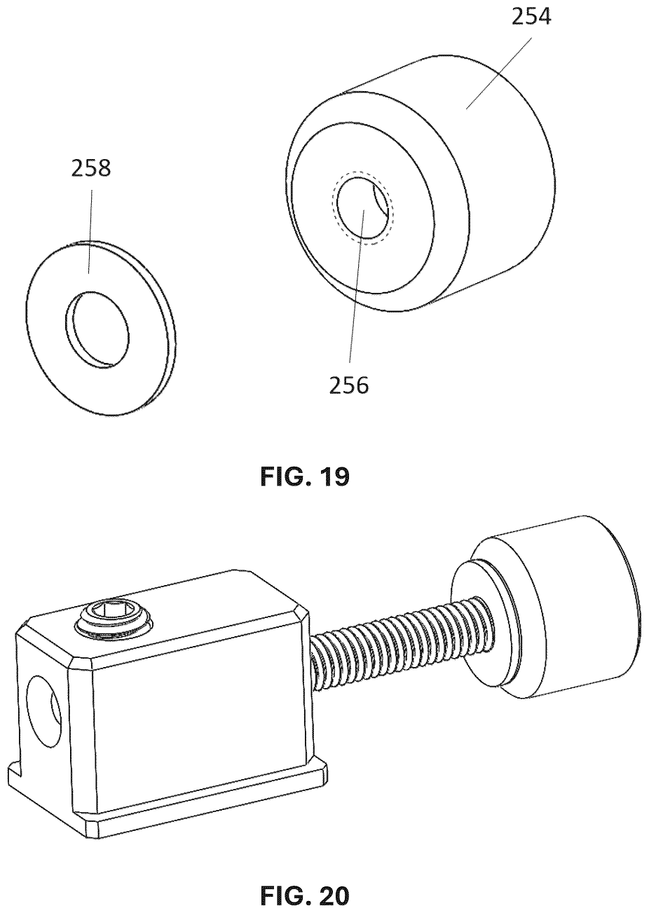

Referring now to FIGS. 19-20, in implementations each fine tuner knob includes a knurled surface 254 and a threaded interface 256 with a specific thread length to reduce friction. A bearing washer 258 is also part of the assembly and functions to reduce friction between the fine tuner knob and the bridge body. Although the knurled nature of surface 254, and the threaded nature of interface 256, are not illustrated in the figures, the practitioner of ordinary skill in the art will nevertheless know how to select knurl and thread details/options according to the desired finger friction and rotational friction. FIG. 20 shows the elements of FIG. 19 coupled with the elements of FIG. 18 to form a string clamp assembly with a fine tuner knob.

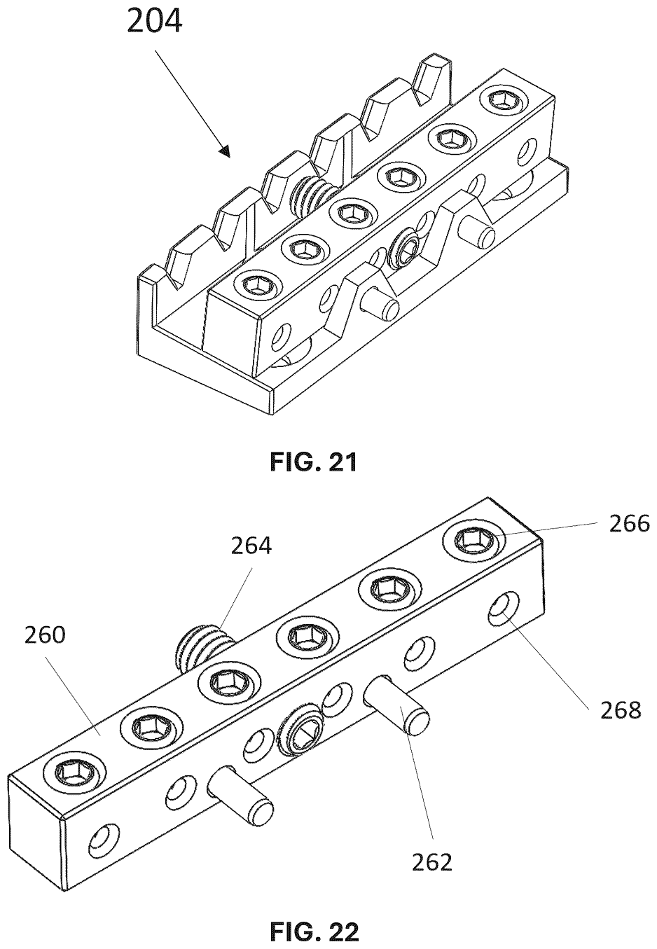

Referring now to FIGS. 21-23, in implementations the nut module 204 includes a nut body 260, a pair of guide pins 262, a tensioning screw 264 (which may also be called a release screw or a tensioner), and the string clamping screws 266. The nut body contains specifically-spaced string through-holes 268 which align with the notches 278 on the nut baseplate. The guide pins keep the nut body in position with respect to the nut baseplate while allowing the nut to move towards and away from the guitar bridge. The guide pins also counteract the moment created by the string tension. The tensioning/release screw applies tension to the strings when fully extended or reduces the tension to zero when fully retracted (when the strings are locked by locking screws 266). In implementations the tensioner adjusts the tension of the strings between a preset range determined by a dimension of the nut baseplate. For example if the tensioner is rotated in a loosening direction eventually the nut body will travel toward the bridge direction until the nut body abuts a portion of the nut baseplate, such the continued rotation of the tensioner in that direction will not further reduce string tension. Similarly, if the tensioner is rotated in the tightening direction the nut body will eventually abut the other side of the nut baseplate such that the tensioner cannot further increase the string tension. In implementations a preferred method of using the musical instrument system includes adjusting the nut body, with the tensioner, to the most forward position (in other words, furthest away from the bridge) until the strings cannot be tensioned more due to the previously discussed abutment of the nut body with a portion of the nut baseplate, and then (if needed) the user further tunes the strings and adjusts intonation using the other mechanisms and/or methods described herein (such as adjusting the saddles and/or using the fine tuners), such that the nut body is generally in the most forward position (furthest from the bridge) while the instrument is played. Thus when a first modular string system or musical system is swapped out for a second, the nut body of the second will be similarly adjusted to the most forward position before further adjusting tuning and/or intonation (if either are needed) to play the instrument. In implementations the most forward position of the nut body may be called the max set point, such that the in-use configuration of each musical instrument system includes setting the nut body to the max set point.

The nut module in implementations also includes a nut baseplate 270. The nut baseplate may include an angled surface 272 (which may also be called an angled interface) to receive the nut body, one cylindrical guide pin receiver 274, one oblong guide pin receiver 276, string notches 278, and recessed countersink screw receivers 280. The angled surface ensures that the strings are pulled down against the bottom of the string notches when the nut module is installed and when the tensioning screw is fully extended. The circular guide pin receiver maintains the nut body position and counteracts the moment created by the strings. The oblong guide pin receiver serves the same purpose as the circular receiver but the oblong shape accommodates manufacturing discrepancies, thus preventing unwanted friction and lockup. Normally, nuts used with tremolo systems contain only two recessed countersink screw receivers. The invention disclosed herein uses four countersink screws to provide additional clamping force between the nut baseplate and the guitar neck. This is done to prevent rotation of the baseplate and to reduce/eliminate hysteresis of the string tuning when the tremolo arm is used.

Referring now to FIG. 24, a tremolo leveling tool 282 was created to assist with the swap of the modular string systems. In implementations the tremolo leveling tool includes a body 284 and a thumb screw 286. The body of the device has a threaded hole to receive the thumb screw. The body also has an angled portion 288 and an extension 290 for handling. The thumb screw controls the height of the tremolo leveling tool to accommodate different bridge cavity depths.

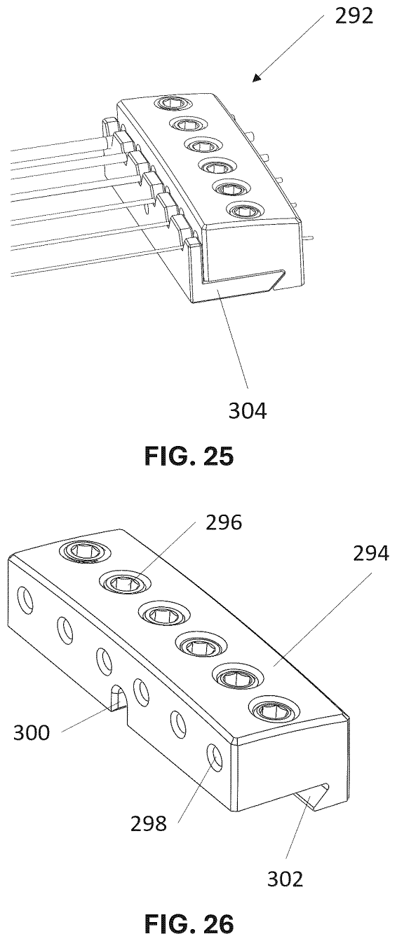

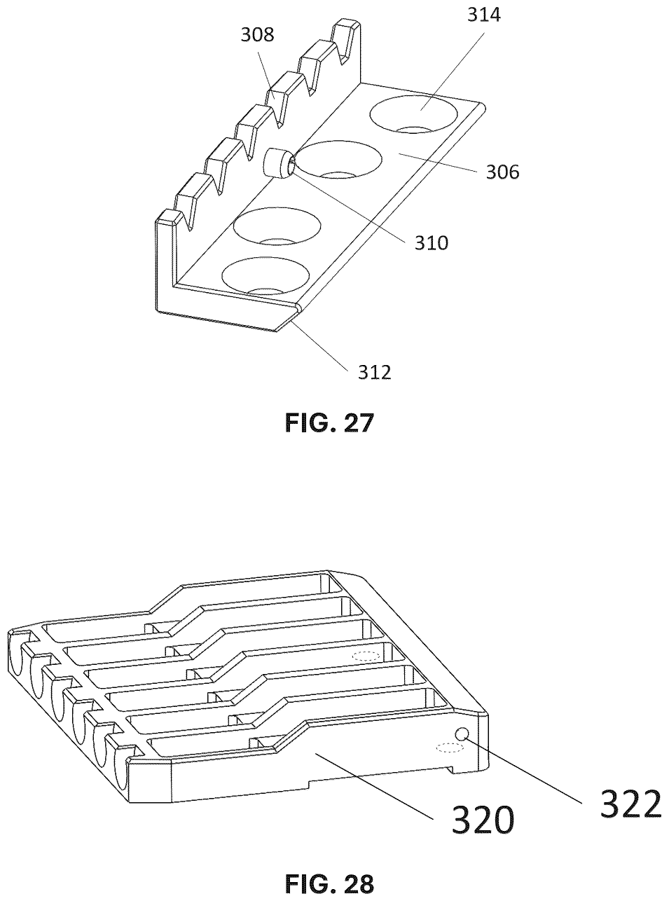

Referring now to FIGS. 25-27, an alternate nut module 292 is representatively illustrated. In implementations this nut module includes a removable nut body 294, string clamping screws 296, string through-holes 298, guide pin channel 300, and an angled surface 302 (which may also be called an angled feature) which resists the translational and rotational movement created due to the tension on the strings. The angled feature interfaces with nut baseplate 304. In implementations nut baseplate 304 includes a base 306, string notches 308, a guide pin 310, an angled surface 312 (which may also be called an angled interface), and recessed countersink holes 314. Nut module 292 is especially useful when used in conjunction with a string tension release mechanism present on the bridge side of the system, such as that described immediately below.

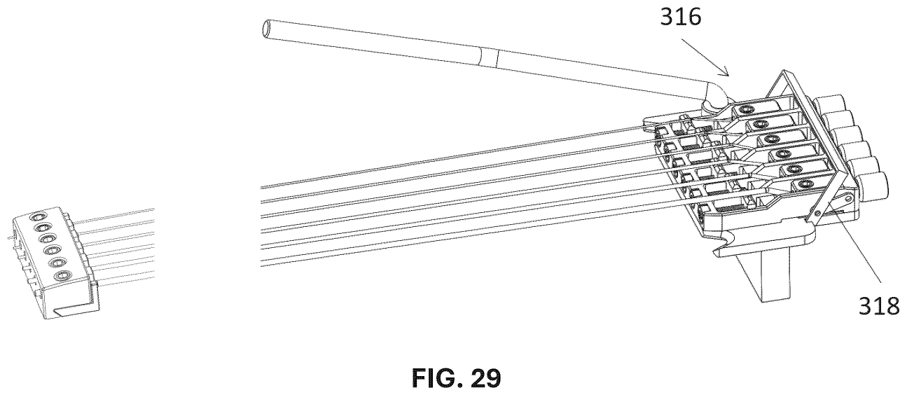

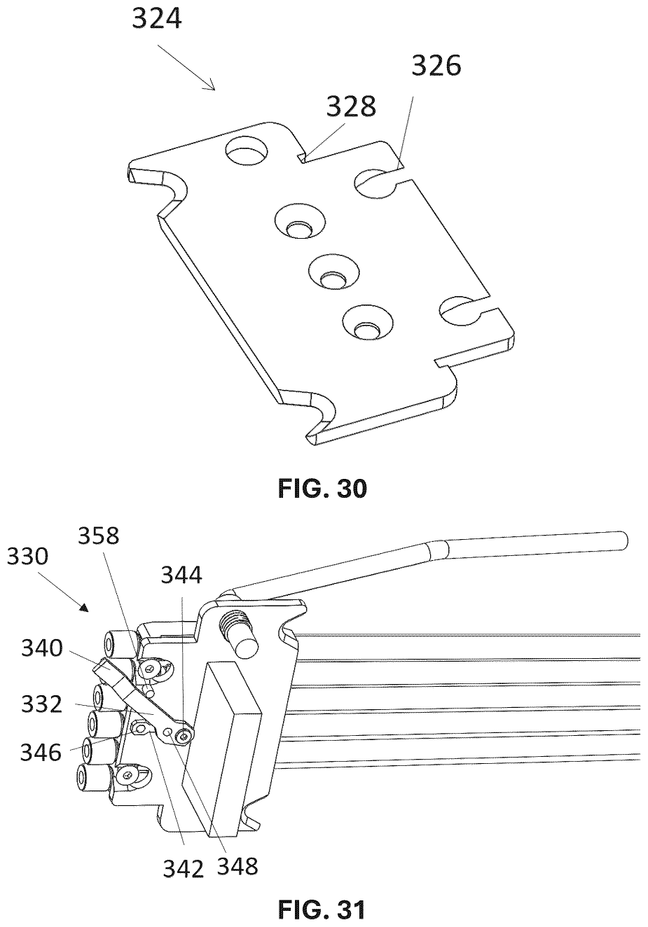

Referring now to FIGS. 28-30, an alternate bridge module 316 includes or is operable with one or more release mechanisms. While above-described embodiments of modular string systems use a release screw present at the nut module, the embodiment of FIGS. 28-30 uses a latch mechanism 318 (which may also be called a tensioner) which is integral to the bridge module 316. A different bridge body 320 includes blind holes to receive latch pins 322. The bridge baseplate 324 for this embodiment is also different and has chamfered engagement screw slots 326 to allow removal of the bridge body from the bridge baseplate once the latch is disengaged, and recesses 328 to interface with the latch mechanism for locking/unlocking the bridge body. In some cases the latch mechanism may keep the musical instrument system secured in place in part by, when being adjusted to a first position, pulling the bridge module away from the nut module to increase the string tension sufficiently that the nut module is kept in place (but without longitudinally moving the engagement screws of the bridge module sufficiently to enable the bridge module to separate from the bridge baseplate). The latch mechanism can be adjusted to a second position to reduce the string tension (by moving the bridge module toward the nut module) sufficiently to allow removal of the nut module from the nut baseplate (made possible by the reduced string tension) and then the bridge module may be easily removed from the bridge baseplate. These steps may be reversed to secure nut module and bridge module in place.

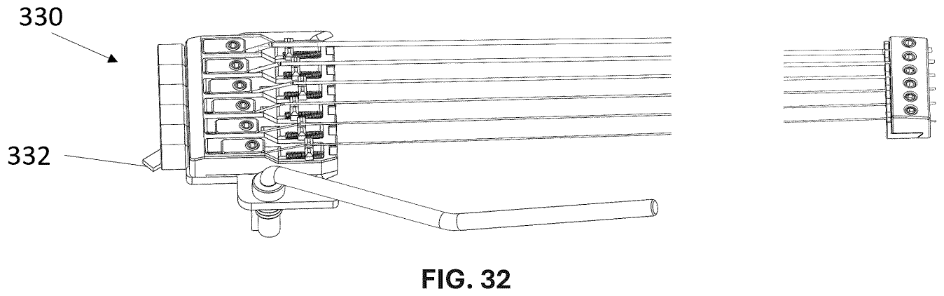

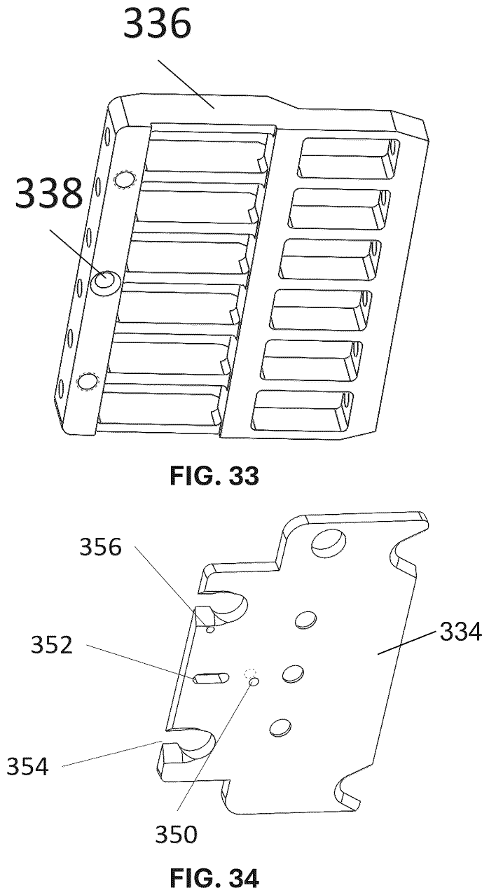

Referring now to FIGS. 31-34, an alternate bridge module 330 includes a latch mechanism 332 which is coupled with bridge baseplate 334. The latch mechanism includes a first latch arm 340 coupled to the bridge baseplate at threaded hole 350 with a latch attachment screw 344 (the screw is also positioned within a hollow cylindrical spacer, not shown, situated between the first latch arm and the bridge baseplate), a second latch arm 342 coupled with the first latch arm using a coupler pin 348, and a second latch pin 346 coupling the second latch arm with a receiver pin hole 338 of the bridge body 336 through slot 352. The bridge baseplate further includes chamfered engagement screw slots 354 and a pin hole 356 for the latch limiter pin 358. The first latch arm 340 may also be called a tensioner and may serve to keep the musical instrument system secured in place in part by, when being rotated to a first position, pulling the bridge module away from the nut module to increase the string tension sufficiently that the nut module is kept in place (but without longitudinally moving the engagement screws of the bridge module sufficiently to enable the bridge module to separate from the bridge baseplate). The first latch arm can be rotated to a second position to reduce the string tension (by moving the bridge module toward the nut module) sufficiently to allow removal of the nut module from the nut baseplate (made possible by the reduced string tension) and then the bridge module may be easily removed from the bridge baseplate. These steps may be reversed to secure nut module and bridge module in place.

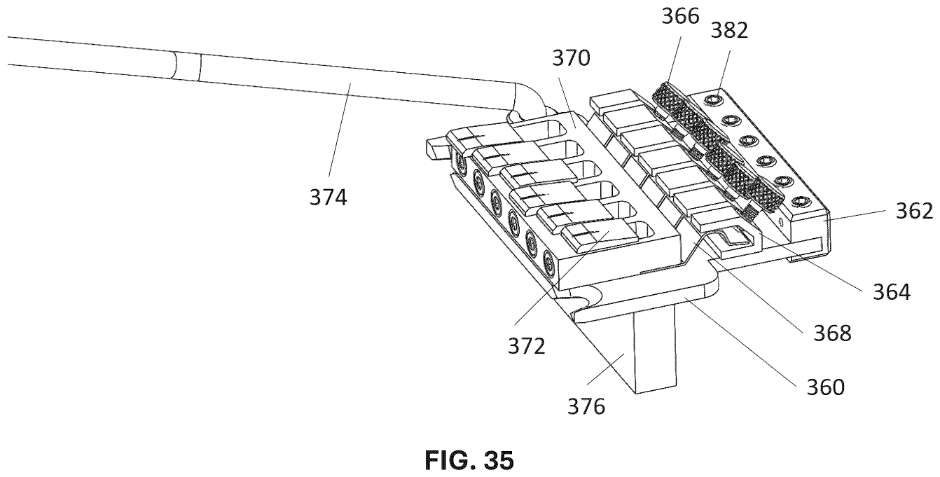

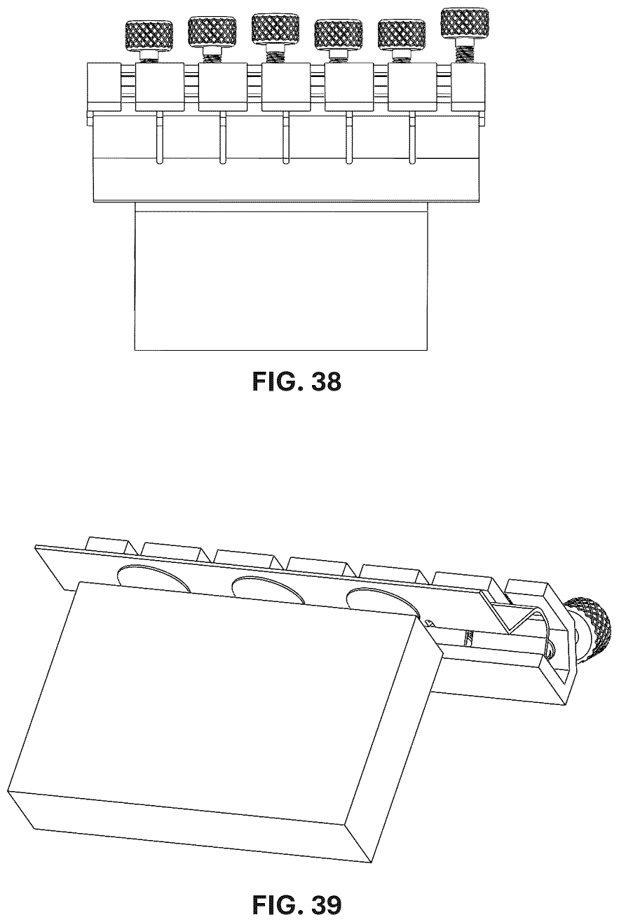

Referring now to FIGS. 35-41, elements of a different embodiment of a musical instrument system (which may also be called a modular string system) are shown. FIGS. 38-41 show different close-up views from different angles (in some cases with elements removed for ease of viewing other elements). This system includes: an alternate bridge baseplate 360, a bridge string block 362, a fine tuner holder 364 which has gaps through which the strings pass to where they are secured using screws 382, fine tuner thumb screws 366, fine tuner springs 368, a saddle holder 370, adjustable saddles 372, a tremolo arm 374 and a tremolo block 376. In this embodiment, the bridge string block contains a release screw 378 which lowers the string tension to zero once it is unscrewed, allowing the nut module 380 to be unhooked and removed, thus allowing the modular string system to be removed from the guitar. The gaps of the fine tuner holder 364 also facilitate the removal and reinstallation of the modular string system. For example, once the release screw is released and the nut module has been removed, the strings can simply pass upward through the gaps in the fine tuner holder to remove the bridge string block and strings from the bridge baseplate and other bridge-related elements. During reinstallation the user can place the bridge string block in place (including passing the strings through the gaps of the fine tuner holder to rest the strings onto the fine tuner springs), then place the nut module in place and/or install it, then tighten the release screw. The gaps between fine tuner springs 368 allow fine turning of individual strings since each fine tuner thumb screw will generally only affect the portion of the fine tuner spring pertaining to one string. In this embodiment, the string saddles and fine tuners stay coupled with the bridge baseplate during installation and removal of the modular string system to/from a guitar. The guitarist may need to adjust the intonation every time a different tuning is used, however. Only the nut module, the bridge string block and strings are removed to switch tunings.

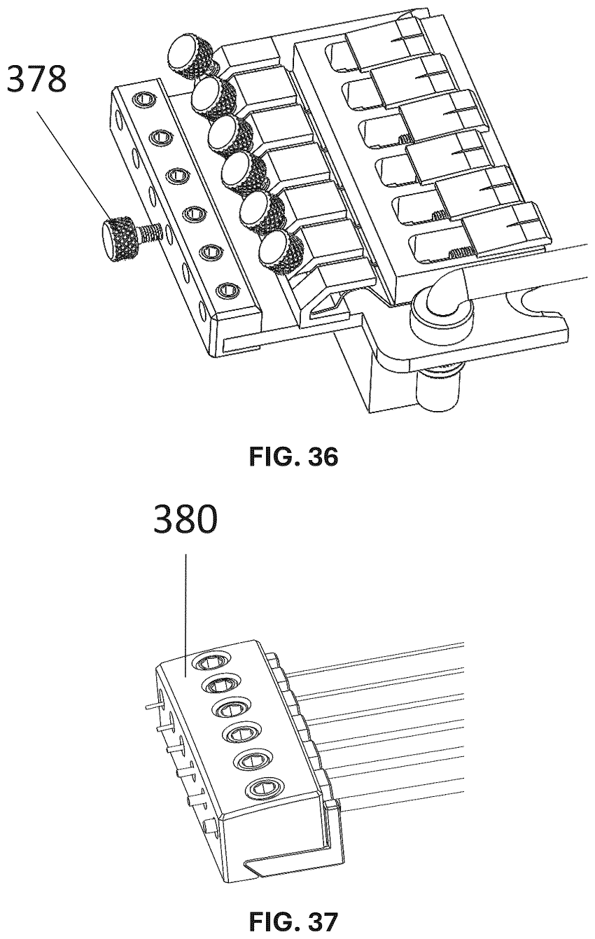

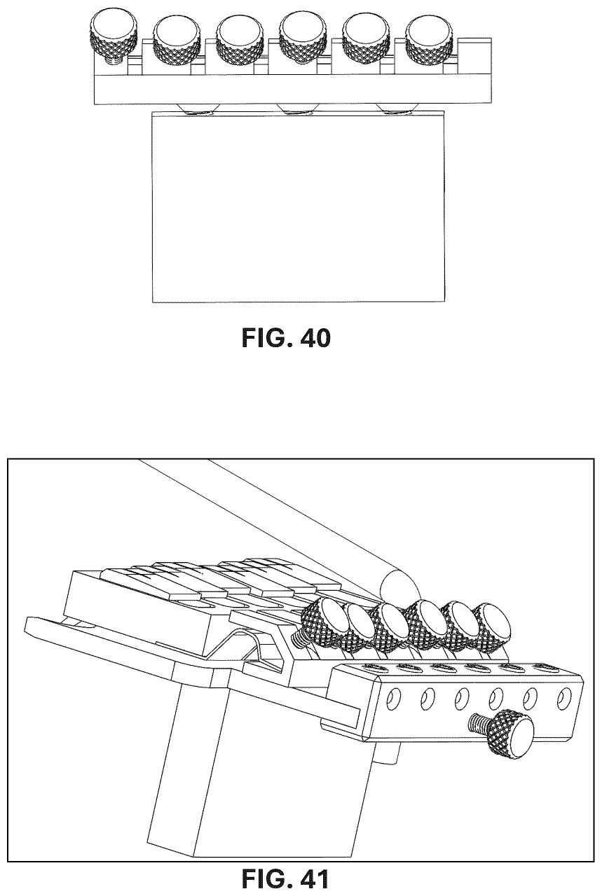

FIG. 38 is a top, front view of some components of FIG. 35, namely, the fine tuner thumb screws 366, fine tuner holder 364, fine tuner springs 368, and tremolo block 376. The view of FIG. 38 reveals how each string can rest on a single gap-separated portion of the fine tuner spring element while also passing through a corresponding gap in the fine tuner holder to couple to the bridge string block 362. FIG. 39 shows the same elements as FIG. 38 but the elements are rotated so that FIG. 39 shows a front, bottom, left perspective view of the elements. In this view heads of the screws that secure the bridge baseplate 360 to the tremolo block 376 are visible. FIG. 40 also shows the same elements as FIG. 38 but the elements are rotated so that FIG. 40 shows a front view. FIG. 41 shows the same elements as FIG. 36 but from a rear, left, top perspective view.

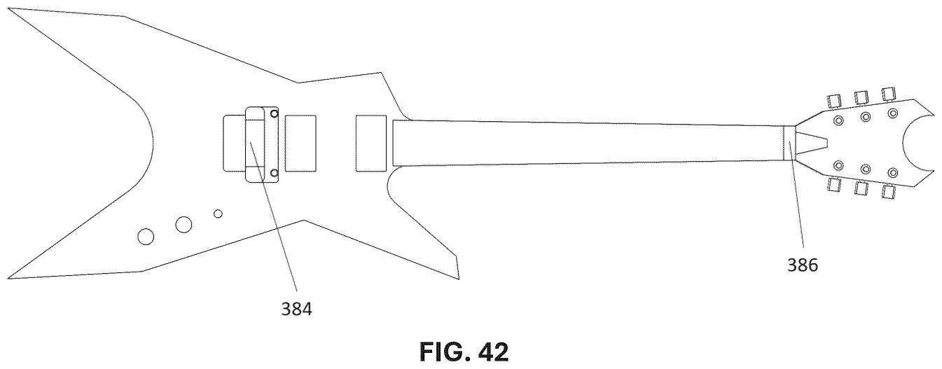

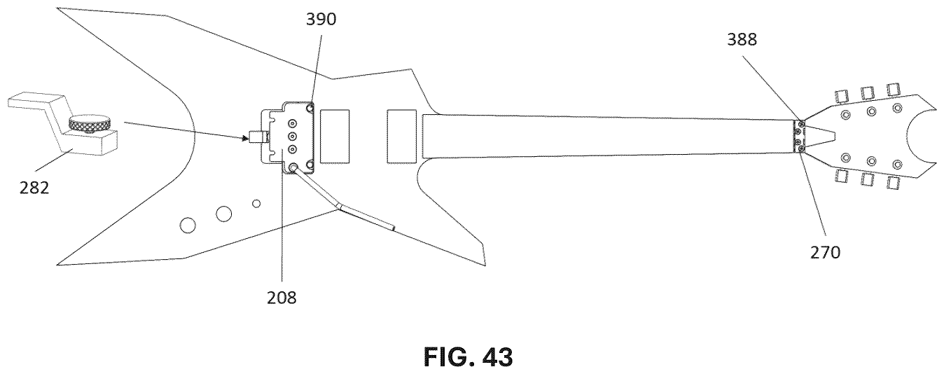

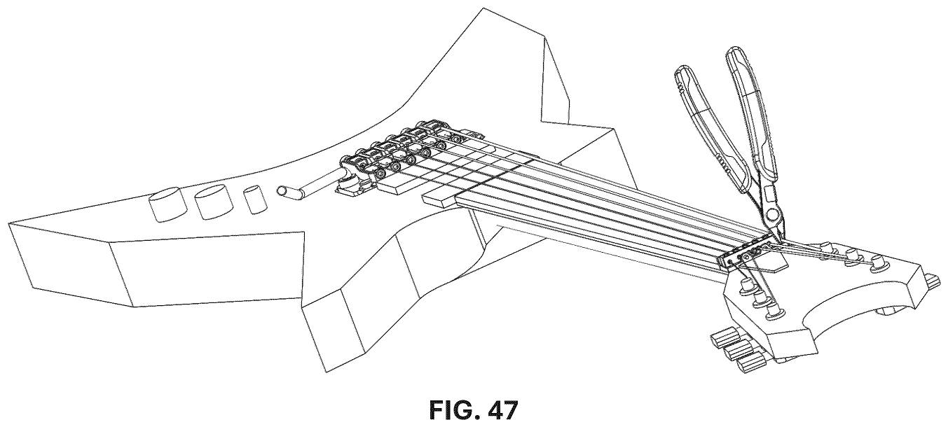

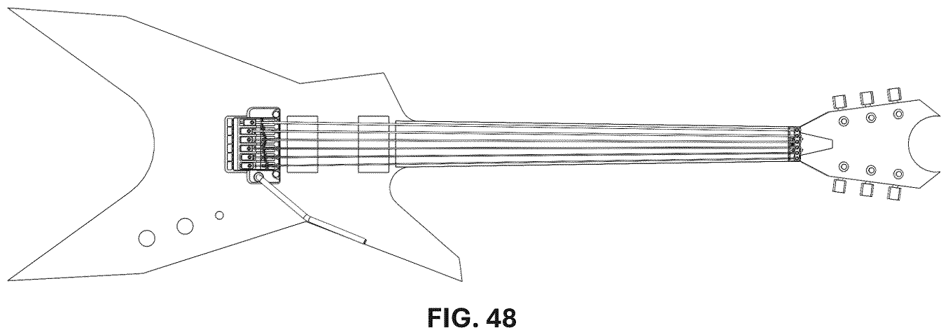

Example installation and removal procedures are shown in FIGS. 42-52. Referring to FIG. 42, the user removes the original tremolo bridge and original locking nut. The guitar should have the proper tremolo bridge cavity 384 and the proper nut seat 386 size (length, width, and depth). Referring to FIG. 43, the user installs a bridge baseplate (e.g., bridge baseplate 208) and a nut baseplate (e.g., nut baseplate 270). In implementations the user may use four wood screws to install the nut baseplate. In implementations the original tremolo posts may be replaced with the new posts 390 provided with the new system/kit or, in some implementations, the user may reuse the preexisting tremolo posts. After connecting the back springs to the tremolo block 221 (which in implementations may be part of the sold musical instrument system 200 or in other implementations the system may be sold without a tremolo block and the user uses a separate tremolo block), the user may insert a tremolo leveling tool 282 between the bridge cavity and the bottom of the bridge baseplate, as representatively illustrated in FIG. 43.

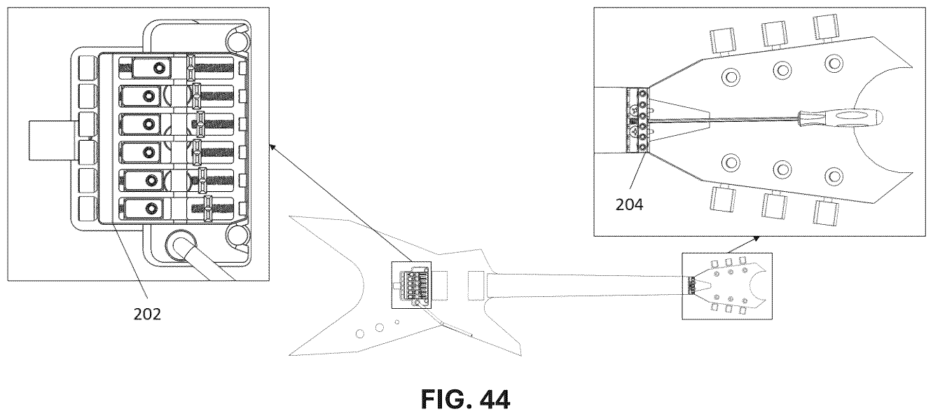

Referring now to FIG. 44, the user may install the bridge module (e.g., bridge module 202) and the nut module (e.g., nut module 204). The bridge module will simply slide in place. The user ensures the engagement screws on the bridge module are aligned with the chamfered channels on the bridge baseplate and slides the bridge module toward the guitar neck. It is useful to position the string clamps halfway along their respective channels to allow enough travel for the fine tuners to be able to tune the strings up or down after installation. The nut module is placed on the nut baseplate and slid toward the guitar headstock. The user extends the tensioning/release screw until it touches the nut baseplate. The body of the nut module should be snug against the nut baseplate guide pin receivers.

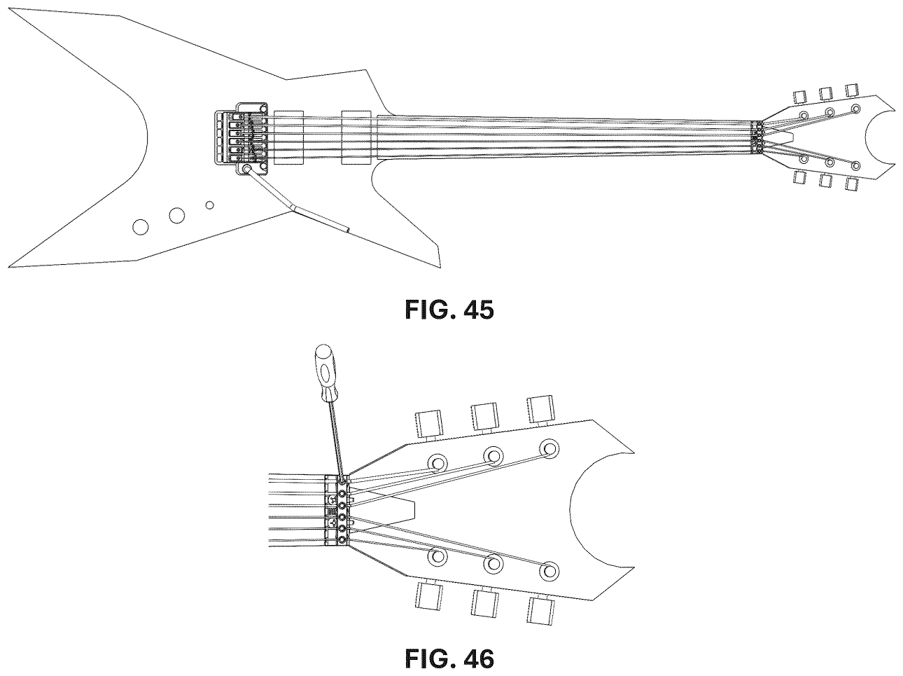

Referring to FIG. 45, the strings are installed as typically done on a guitar with a double locking tremolo system. The user may write down the total string tension (combined tension of all strings). This is typically provided by string manufacturers but if not the user may use an online string tension calculator. This step is useful because subsequent alternate tunings which use the same total string tension would keep the bridge leveled once a new string module is installed. For example, a typical 10-46 gauge string set installed in a guitar with a 25.5 inch scale length provides approximately 110 lb. of total tension.

The user tunes the strings and then removes the tremolo leveling tool. The user may check the tuning and adjust as needed. The intonation of each string may be adjusted using the saddle screws. The bridge height is adjusted using the bridge posts as needed. The user may adjust the bridge level if needed using the springs on the back of the guitar (the original springs can be used). Note that the nut baseplate may need to be shimmed or the nut seat may need to be filed down to achieve optimum nut height.

Referring now to FIGS. 46-48, the strings are locked by tightening the string screws on the nut module. Another string tuning check may be done after deflecting the tremolo arm back and forth twice. The bridge fine tuners may be used to tune any strings that might have gone out of tune, and the bridge level may be adjusted if needed. With the strings still clamped by the nut module, the machine heads are adjusted to release the tension of the string section between the machine heads and the nut module. Using a wire cutter, the user cuts the strings approximately 1-2 mm past the nut module on the headstock side. The user removes the cut string sections between the nut module and machine heads. At this stage the guitar is now ready to be played. If desired, different tunings can be set up by using a new string set with another bridge module and nut module.

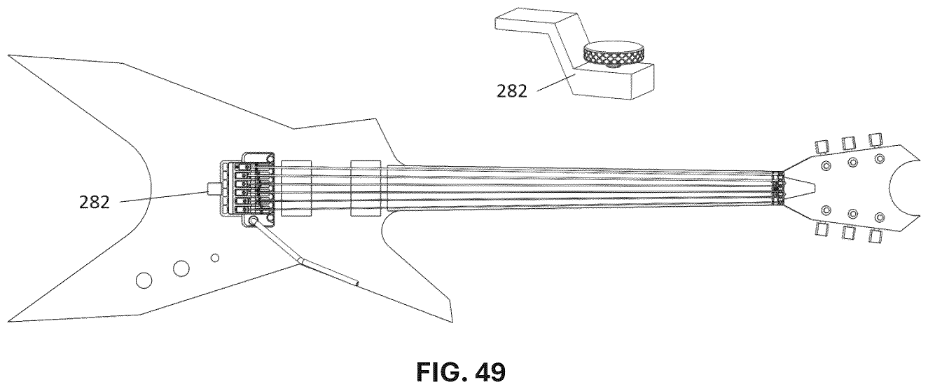

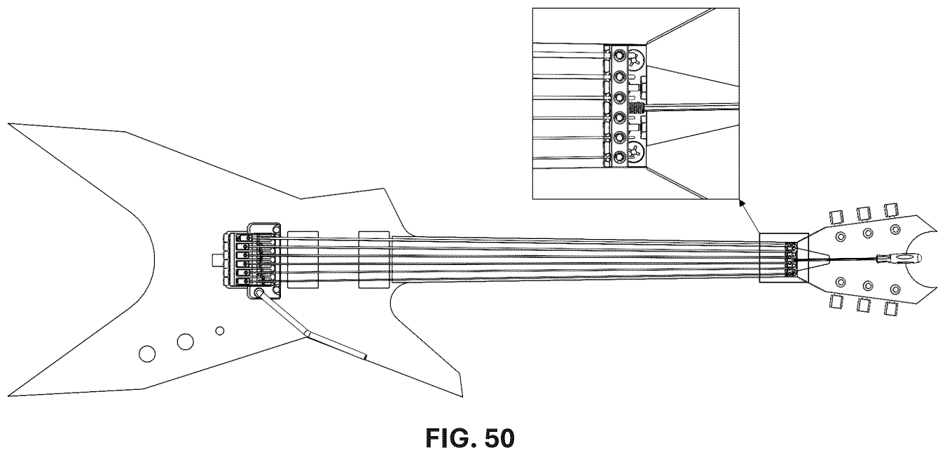

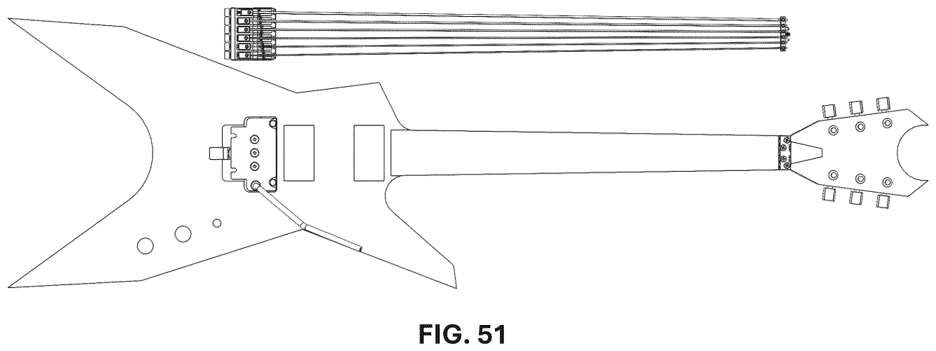

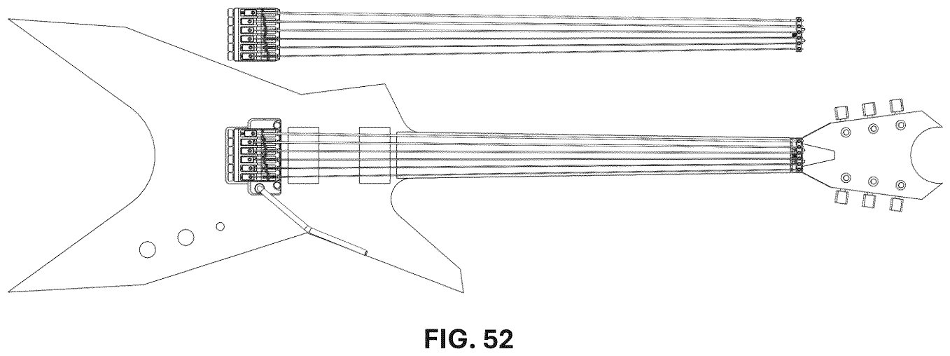

Referring now to FIG. 49, to remove the modular string system (or musical instrument system), the tremolo leveling tool 282 is first placed under the bridge to keep the bridge leveled. In order to provide enough space to insert the tremolo leveling tool, the user deflects the tremolo arm forward while inserting the tremolo leveling tool. Referring to FIG. 50, the user loosens the tensioning/release screw to allow the nut module to move toward the guitar body and to bring the tension on the strings to zero. Referring to FIG. 51, the nut module is removed and the bridge module is carefully slid away from the pickups to remove the modular string system off the guitar. The user may store the removed modular string system for later use. Ther user may leave the tremolo leveling tool in place to aid in installing the next modular string system. Referring to FIG. 52, the user may use a second set of strings, bridge module and nut module and, following the same procedure used to set up the first modular string system, may install a second modular string system with a different tuning.

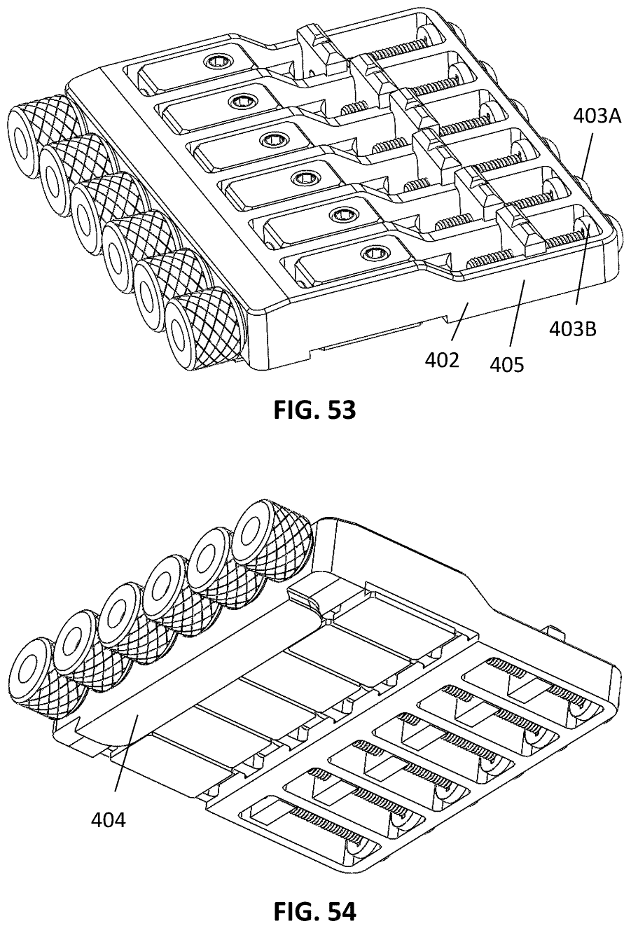

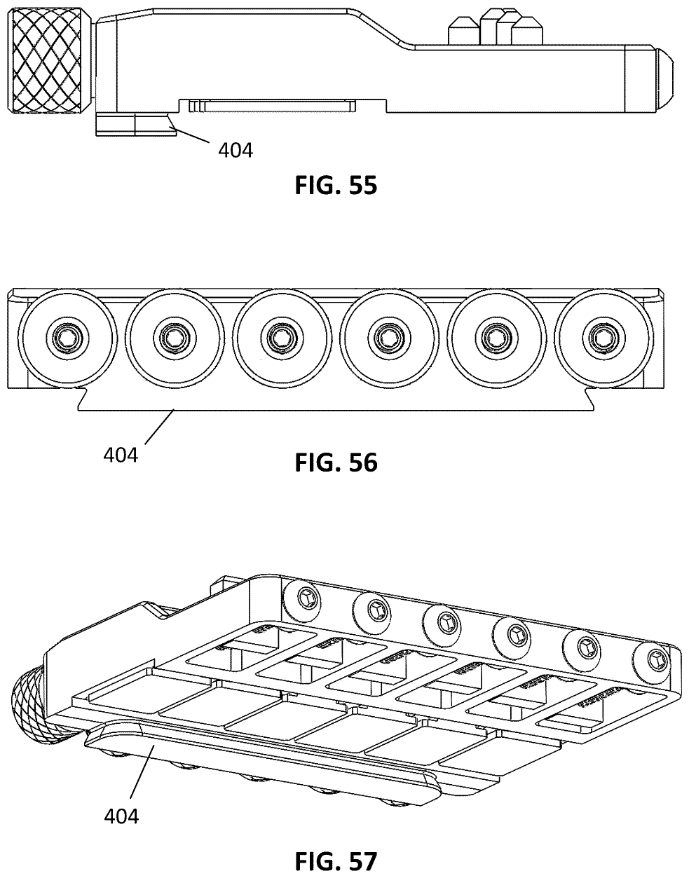

FIGS. 53-57 show various views of another bridge module. Bridge module 402 may be used in combination with other elements, such as those disclosed herein, to form a musical instrument system. Bridge module 402 may be similar in many respects to bridge module 202, including a bridge body 405, fine tuners, string clamps, string saddles, and so forth. One way in which it differs is that instead of having engagement screws 224, bridge module 402 includes an integral wedge 404. Additionally, threaded adjusters 403A, used for saddle positioning, are button-head screws/bolts (as opposed to the socket-head screws/bolts of FIG. 5). The button-head screws/bolts in some cases are configured with a small hex driver hole that matches other hex driver holes in the musical instrument system so that a user could adjust all threaded fasteners/adjusters of the system using a single driver (by non-limiting example, a 2 mm hex driver/screwdriver). Each threaded adjuster 403A has one or more grooves (not shown) to accommodate a retainer clip 403B, which snaps in place and prevents the threaded adjuster from moving longitudinally (i.e., along the longest length of the threaded fastener, which is collinear with its rotational axis) as the threaded adjuster rotates about the rotational axis to move the corresponding saddle forward and backward as desired.

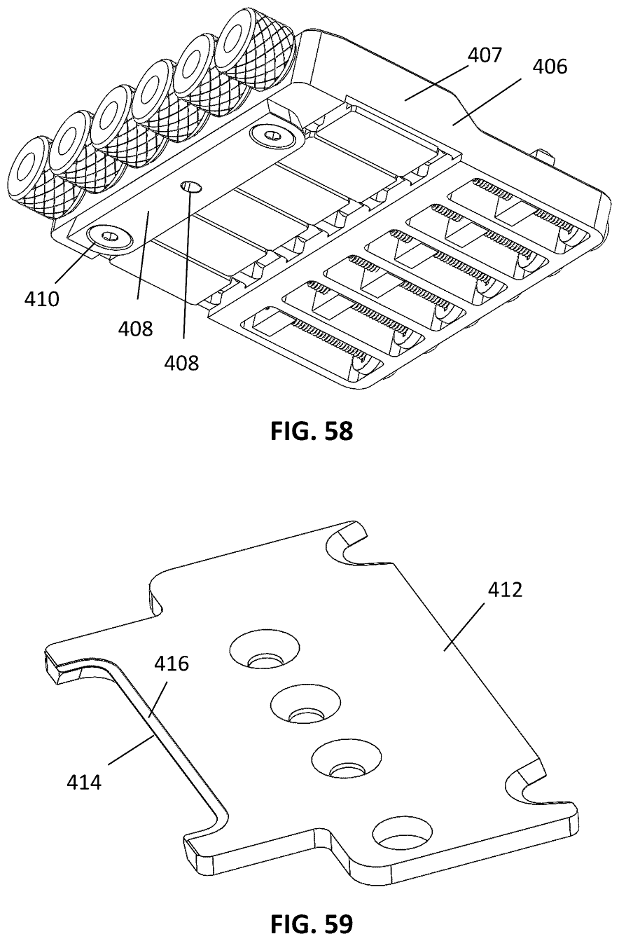

FIG. 58 shows another bridge module. Bridge module 406 includes a bridge body 407, fine tuners, string clamps, string saddles, and so forth, similar to bridge module 402, but instead of an integral wedge it has a removable wedge 408 that is bolted on by passing one or more threaded fasteners 410 (which may for example be screws or bolts) through corresponding through-holes in the removable wedge 408 and into corresponding threaded holes of the bridge module 406. Although the through-holes and corresponding threaded holes are not shown in the drawings, the practitioner of ordinary skill in the art will know how to select hole and thread sizes in the like and to provide these features. A hole 409 may be included and may align with a corresponding guide pin (not shown) extending downward from the bridge body of bridge module 406. The guide pin may be integrally formed in the bridge body or secured thereto. In some cases the guide pin may have the same height as the hole 409 such that its bottom face is flush with the bottom face of removable wedge 408, or in other cases it could be shorter such that it does not extend all the way to the bottom face of removable wedge 408. Although the guide pin is not shown in the drawings, it may be similar to other pins shown herein (for example guide pins 262, guide pin 310) and accordingly the practitioner of ordinary skill in the art will understand how to implement it without its being shown. The guide pin and corresponding hole 409 assist with assembly by making sure the removable wedge 408 is properly centered on the bridge body before securing it thereto using the threaded fasteners 410.

The integral nature of integral wedge 404, and the removable nature of removable wedge 408, each have different advantages and tradeoffs. There are fewer assembly steps with integral wedge 404, but when providing a finish (e.g., chrome plating) on the wedge and/or the bridge body it has been found that finish thickness variation may make it more difficult for the wedge to interface well with the corresponding bridge baseplate. With the removable wedge 408 a shim can be placed between the bridge body and the removable wedge 408, if needed, to compensate for different finish thicknesses on the wedge and/or bridge body. The removable wedge 408 accordingly allows for adjustment of the final wedge positioning up or down relative to the bridge body, by using variously-sized shims, which can compensate for discrepancies in the finish thickness(es). On the other hand, if the finish process is one which is more predictable (controlled to have very little variation) then integral wedge 404 may be more desirable, to remove manufacturing/assembly steps.

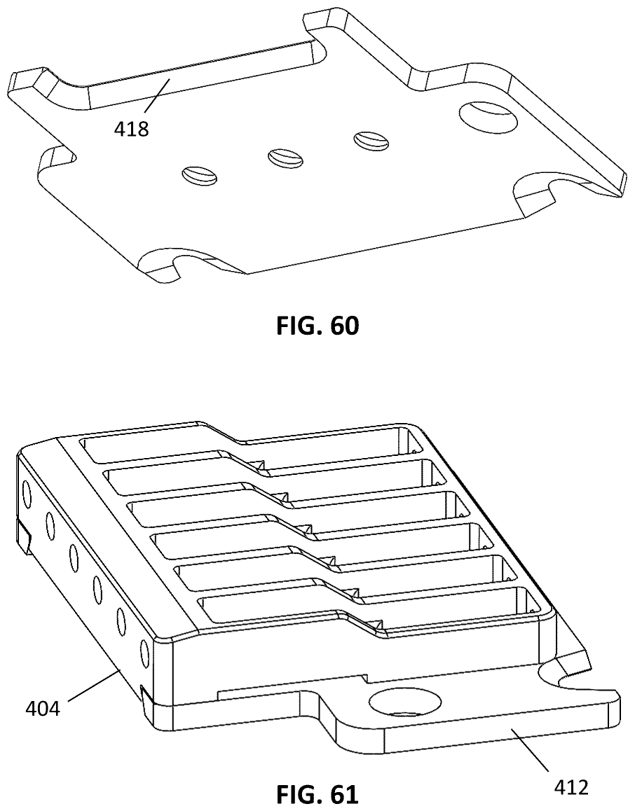

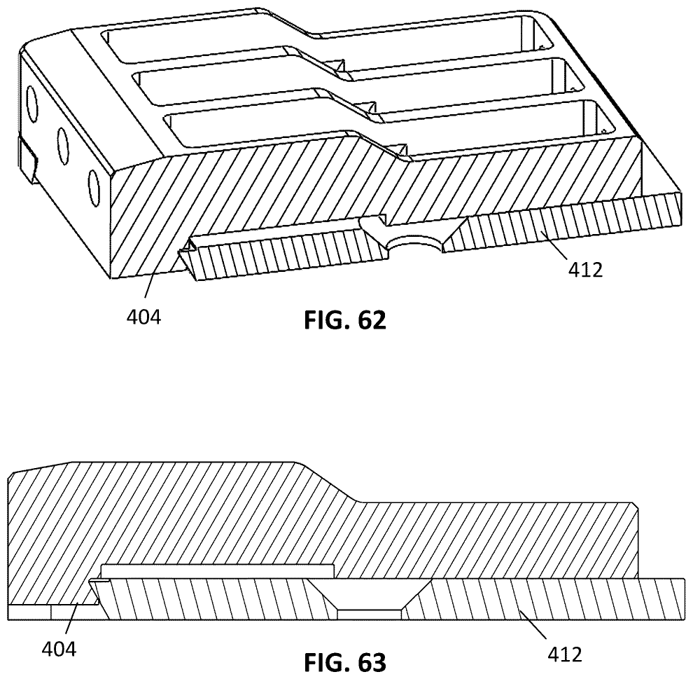

FIGS. 59-60 show views of a bridge baseplate. Bridge baseplate 412 is identical to bridge baseplate 208 except that, instead of having two smaller chamfered channels 210, a single, wide chamfered channel 414 or recess is present. Also, there are both a top angled surface 416 and a bottom angled surface 418 corresponding with chamfered channel 414, which in implementations may further help mating the corresponding bridge module therewith. Bridge baseplate 412 is specifically designed for receiving the corresponding wedges of bridge module 406 and bridge module 402. For example, FIG. 61 shows integral wedge 404 of bridge module 402 secured/mated to the chamfered channel of bridge baseplate 412. FIG. 63 shows the same elements as FIG. 61 but in cross-section, and that the integral wedge 404 can be seen within the chamfered channel of the bridge baseplate 412. FIG. 63 shows the same elements as FIG. 62, but from a right side view. FIGS. 62-63 accordingly representatively illustrate the engagement mechanism between the wedge and the corresponding chamfered channel 414. The removable wedge 408 of bridge module 406 would engage with the chamfered channel 414 in a similar manner.

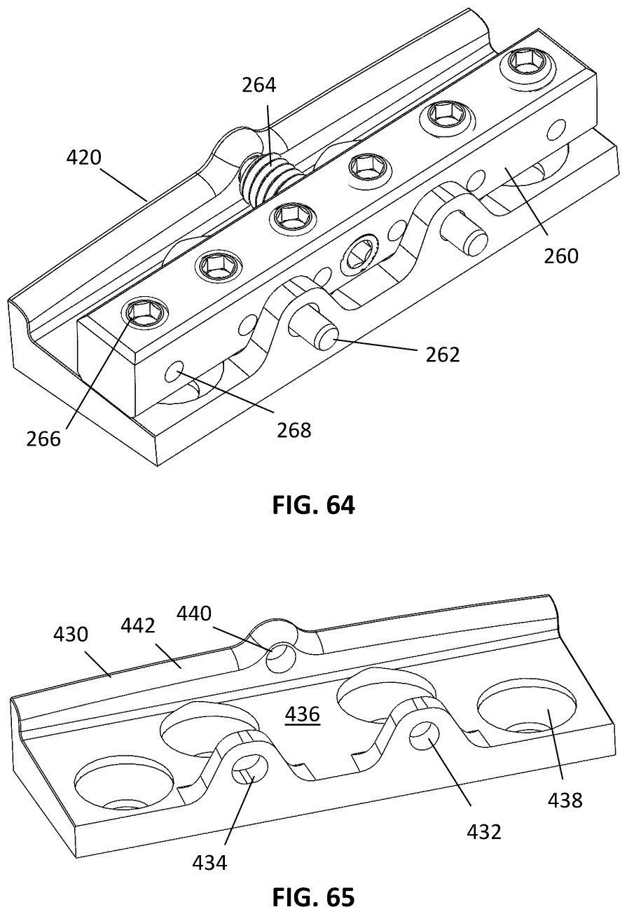

FIGS. 64-65 show elements of another implementation of a nut module. Nut module 420 is similar in some ways to nut module 204 but in some ways different. Nut module 420 may use the same nut body 260, screws 266, specifically-spaced string through-holes 268, tensioning screw 264, and guide pins 262. The nut baseplate 430 of nut module 420 may have one cylindrical guide pin receiver 432 and one oblong guide pin receiver 434, angled surface 436, and recessed countersink screw receivers 438, each having similar or identical functions as those described for correspondingly-named elements of nut baseplate 270. Nut baseplate 430 is noticeably missing the notches 278 of nut baseplate 270. These notches/grooves are, however, optional. In some cases a nut baseplate may include them, and in others (such as nut baseplate 430) they may be excluded. When they are excluded, the strings will contact/engage with and/or abut the upper surface 442 in the installed configuration (which in some cases may help with proper tuning and/or intonation and/or may have other advantages. In some cases the upper surface is rounded, as in FIGS. 64-65. Nut baseplate 430 includes a positioning hole 440. This has a smaller diameter than the largest diameter of the tensioning screw 264, but the terminal end of the tensioning screw 264 is small enough to sit within the positioning hole 440, and the positioning hole 440 accordingly helps to prevent the terminal end of the tensioning screw 264 from moving upward (or otherwise moving out of its desired position) while the tensioning screw is being tightened. The guide pins 262 keep the nut body centered during tightening and/or loosening.

The engagement screws 224, integral wedge 404, removable wedge 408, and any other devices/features of a bridge module configured to secure it to a bridge baseplate, may be called engagement members (for example, first engagement members). The chamfered channels 210, chamfered channel 414, and any other devices/features of a bridge baseplate configured to secure it to a bridge module, may be called engagement members (for example, second engagement members). The guide pins 262 (which may be integrally formed with the nut body or glued or melt bonded or screwed into or otherwise secured to the nut body), angled surface 302 (which may also be called an angled portion or a projection or an angled projection), and any other devices/features of a nut body configured to secure it to a nut baseplate, may be called engagement members (for example, third engagement members). The cylindrical guide pin receiver 274, oblong guide pin receiver 276, angled surface 312 (which may also be called an angled portion or a projection or an angled projection), and any other devices/features of a nut baseplate configured to secure it to a nut body, may be called engagement members (for example, fourth engagement members). Any of the clamping screws disclosed herein may also be called string clamps. As used herein, the terms “manual” and derivations thereof, such as “manually,” refer to operations capable of being performed using manual force either by hands alone, or using hands and non-powered tools and implements. The terms “non-powered” and derivations thereof refer to tools that do not use electricity, a fuel, or a compressed fluid source (gas or liquid) or the like for their operation. As used herein, the terms “permanent” and derivations thereof, such as “permanently,” refer to couplings that are incapable of being removed/separated/broken using hands alone. As can be envisioned from the drawings, in some cases when a tensioner (such as tensioning screw 264, latch mechanism 318, first latch arm 340, etc.) is adjusted, it simultaneously adjusts a tension of all the strings by moving the respective nut body or bridge body. The tremolo leveling tool 282 can appropriately be called a height-adjustable tremolo leveling tool inasmuch as the height of thumb screw 286 can be adjusted to keep the bridge baseplate level while coupling a bridge body with the bridge baseplate and/or decoupling the bridge body from the bridge baseplate.

In implementations the musical instrument systems disclosed herein comprise or form modular string systems for electric guitars. That being said, the musical instrument systems disclosed herein (and/or components thereof) may be used on a variety of stringed instruments, and the guitar (and, specifically, electric guitar) examples described herein and shown in the drawings are only representative examples.

The various devices and/or assemblies disclosed herein and their elements, sub-elements, sub-assemblies, and so forth may be formed from any materials that will feasibly allow, facilitate, and/or otherwise not hinder their respective functions as described herein. For example, any of the devices, elements, or sub-elements may, wherever possible, be formed of metals, polymers, composites, ceramic materials, fabrics, and so forth.

While each individual above-described element may be configured as shown in the drawings and/or as discussed above, these are only representative examples and other configurations are possible for any individual element, with various advantages and tradeoffs as will be understood by the practitioner of ordinary skill in the art.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of musical instrument systems and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element-if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element-if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order-such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A musical instrument system, comprising:
a bridge module comprising:
a bridge body;
one or more first string clamps coupled with the bridge body or configured to couple with the bridge body, the one or more first string clamps configured to releasably couple a plurality of strings of a musical instrument with the bridge body; and
one or more first engagement members coupled with the bridge body or configured to couple with the bridge body, the one or more first engagement members configured to engage with one or more second engagement members of a bridge baseplate to releasably couple the bridge body with the bridge baseplate, at least in part using tension from the plurality of strings, when the bridge baseplate is secured to the musical instrument; and
a nut module comprising:
a nut body;
one or more second string clamps coupled with the nut body and configured to releasably couple the plurality of strings with the nut body; and
one or more third engagement members coupled with the nut body or configured to couple with the nut body, the one or more third engagement members configured to engage with one or more fourth engagement members of a nut baseplate to releasably couple the nut body with the nut baseplate when the nut baseplate is secured to the musical instrument.

2. The musical instrument system of claim 1, wherein the one or more first engagement members comprise one or more projections extending downward from a bottom surface of the bridge body, the bottom surface facing toward the musical instrument in an installed configuration.

3. The musical instrument system of claim 1, wherein the one or more first engagement members are integrally formed with the bridge body or are permanently secured to the bridge body.

4. The musical instrument system of claim 1, wherein the one or more first engagement members are manually removable from the bridge body.

5. The musical instrument system of claim 1, wherein the one or more first engagement members comprise one or more engagement screws.

6. The musical instrument system of claim 1, wherein the one or more first engagement members comprise one or more wedges.

7. The musical instrument system of claim 1, wherein the one or more second string clamps comprise one or more clamping screws.

8. The musical instrument system of claim 1, wherein the one or more third engagement members comprise one or more guide pins.

9. The musical instrument system of claim 1, wherein the one or more third engagement members comprise one or more angled surfaces.

10. The musical instrument system of claim 1, wherein the nut module further comprises a tensioner configured to, when adjusted, move the nut body to simultaneously adjust a tension of all of the strings.

11. The musical instrument system of claim 1, wherein the bridge module further comprises a tensioner configured to, when adjusted, move the bridge body to simultaneously adjust a tension of all of the strings.

12. The musical instrument system of claim 1, wherein the bridge module further comprises a plurality of adjustable string saddles, each string saddle configured to be adjusted to adjust an intonation of one of the plurality of strings.

13. The musical instrument system of claim 1, wherein the bridge module further comprises a plurality of fine tuners, each fine tuner configured to be adjusted to adjust a tension of one of the plurality of strings.

14. A musical instrument system, comprising:
a bridge module comprising:
a bridge body;
one or more first string clamps coupled with the bridge body or configured to couple with the bridge body, the one or more first string clamps configured to releasably couple a plurality of strings of a musical instrument with the bridge body; and
one or more first engagement members coupled with the bridge body or configured to couple with the bridge body;
a bridge baseplate configured to be secured to the musical instrument, the bridge baseplate comprising one or more second engagement members, wherein the one or more first engagement members are configured engage with the one or more second engagement members to releasably couple the bridge body with the bridge baseplate, at least in part using tension from the plurality of strings, when the bridge baseplate is secured to the musical instrument;
a nut module comprising:
a nut body;
one or more second string clamps coupled with the nut body and configured to releasably couple the plurality of strings with the nut body; and
one or more third engagement members coupled with the nut body or configured to couple with the nut body; and
a nut baseplate configured to be secured to the musical instrument, the nut baseplate comprising one or more fourth engagement members, wherein the one or more third engagement members are configured to engage with the one or more fourth engagement members to releasably couple the nut body with the nut baseplate when the nut baseplate is secured to the musical instrument.

15. The musical instrument system of claim 14, wherein the one or more second engagement members comprise a channel.

16. The musical instrument system of claim 14, further comprising a tensioner coupled with the bridge baseplate and configured to, when adjusted, move the bridge body to simultaneously adjust a tension of all of the strings.

17. The musical instrument system of claim 14, wherein the bridge baseplate further comprises:
a tremolo arm interface configured to couple with a tremolo arm; and
a tremolo block interface configured to couple with a tremolo block.

18. The musical instrument system of claim 14, further comprising a height-adjustable tremolo leveling tool configured to be placed under the bridge baseplate to keep the bridge baseplate level during one of: coupling the bridge body with the bridge baseplate;
and decoupling the bridge body from the bridge baseplate.

19. A method of use of a musical instrument system, comprising:
releasably coupling a plurality of strings of a musical instrument with a bridge body of a bridge module using one or more first string clamps coupled with the bridge body;
releasably coupling the plurality of strings with a nut body of a nut module using one or more second string clamps coupled with the nut body;
securing a bridge baseplate to the musical instrument;
securing a nut baseplate to the musical instrument;
engaging one or more first engagement members, coupled with the bridge body, with one or more second engagement members of the bridge baseplate to releasably couple the bridge body with the bridge baseplate; and
engaging one or more third engagement members, coupled with the nut body, with one or more fourth engagement members of the nut baseplate to releasably couple the nut body with the nut baseplate.

20. The method of claim 19, further comprising simultaneously adjusting a tension of all of the strings by adjusting a tensioner coupled with one of the nut body, the bridge body, and the bridge baseplate; wherein the tensioner simultaneously adjusts the tension of all of the strings by moving one of the bridge body and the nut body.
